(19) United States
(12) Patent Application Publication
(10) Pub. No.: US 2025/0268339 A1
(43) Pub. Date: Aug. 28, 2025

(54) 3D MODEL-ASSISTED SHOE AND SPORTSWEAR BREAK-IN SYSTEM AND METHOD

(71) Applicant: Guowen Cai, Cary, NC (US)

(72) Inventor: Guowen Cai, Cary, NC (US)

(21) Appl. No.: 19/063,269

(22) Filed: Feb. 25, 2025

Related U.S. Application Data
(60) Provisional application No. 63/557,595, filed on Feb. 25, 2024.

(51) Int. Cl. A43D 8/52

(52) U.S. Cl. CPC A43D 8/52

(57) ABSTRACT

An apparatus configured to break in footwear or sportswear includes: a three-dimensional model of a user's feet or body based on scanning or molding, wherein the three-dimensional model comprises a material configured to mimic biomechanical properties of the user's feet or body; a robotic motion simulator configured to simulate user-specific movements to break in the footwear or sportswear; and a controller configured to customize break-in protocols based on user-specific parameters, to thereby break in the footwear or sportswear emulating a process of the user's wearing the footwear or sportswear to break in without user discomfort while optimizing fit of the footwear or sportswear.

### CROSS-REFERENCE TO RELATED APPLICATION

The present disclosure claims priority to U.S. Provisional Patent Application No. 63/557,595 filed on Feb. 25, 2024, the disclosure of which is hereby incorporated by reference in its entirety.

### BACKGROUND

The disclosure relates to the field of footwear customization and fitting, particularly focusing on methods and devices for breaking in new shoes using personalized 3D models of an individual's feet. The field encompasses various technologies aimed at improving shoe fit and comfort, including 3D scanning, pressure mapping, and customized footwear components. Some implementations in this field includes systems for selecting best-fit footwear from multiple options based on 3D models of user anatomy, methods for creating customized arch supports, and pressure-mapped midsoles designed to enhance comfort based on pressure data from the foot.

In the field of footwear fitting, a common challenge is achieving a comfortable fit with new shoes, especially specialized sports footwear such as ski boots, hiking shoes, and tennis shoes. New shoes often cause discomfort due to stiffness and improper fit, leading to issues like blisters and sore feet. Existing methods primarily focus on selecting the best-fit shoe from available options or customizing specific shoe components like insoles. However, these approaches do not address the dynamic adaptation of the shoe to the user's foot, which is crucial for achieving an optimal fit and reducing discomfort during the initial wear period.

There is a need in the art for improved methods and devices that not only select or customize shoe components but also actively modify the shoe to fit the user's foot through a dynamic break-in process. Current technologies do not adequately simulate real-life movements to adapt new shoes to the user's unique foot shape and biomechanics. Some implementations lack solutions that leverage personalized 3D models to emulate the exact properties of a user's feet, including size, stiffness, and texture, and use these models in conjunction with robotic simulation to break in shoes under realistic conditions. This disclosure addresses these gaps by providing a comprehensive approach to shoe break-in, ensuring both comfort and performance through advanced 3D modeling and simulation techniques.

### SUMMARY

This disclosure relates to a system and method for breaking in footwear and sportswear. The system comprises a 3D model creation module configured to generate a three-dimensional model of a user's feet or body using scanning technologies. The scanning technologies may include 3D scanning or photogrammetry. The 3D model creation module captures anatomical features such as arch height, toe structure, and skin texture. A material emulation module is configured to select materials for the 3D model that mimic the biomechanical properties of the user's feet or body, including flexibility and thermal characteristics.

The system further includes a robotic motion simulator configured to simulate user-specific movements to break in the footwear and sportswear. The robotic motion simulator is capable of replicating complex human motions, including walking, running, and sport-specific actions. A control module is configured to customize break-in protocols based on user-specific parameters, such as weight distribution, gait analysis, and activity type, thereby reducing discomfort and optimizing the fit of the footwear and sportswear.

The method for breaking in footwear and sportswear involves generating a 3D model of a user's feet or body using advanced scanning technologies, selecting materials for the 3D model that emulate the biomechanical properties of the user's feet or body, and fitting the footwear or sportswear onto the 3D model. The method includes simulating user-specific movements with a robotic motion simulator to break in the footwear or sportswear and customizing the break-in protocol based on user-specific parameters to reduce discomfort and optimize fit.

The disclosure also encompasses a system for pre-conditioning footwear and sportswear, comprising a 3D model creation module for generating a detailed model of a user's feet or body, a material emulation module for selecting materials that mimic the user's biomechanical properties, a robotic motion simulator for simulating user-specific movements, and a control module for customizing break-in protocols. This system enhances the fit and comfort of the footwear and sportswear by the following steps.

Step 100: Scanning the user's feet. The user places his or her feet on the 3D scanner 10, and the 3D scanner 10 scans the user's feet and generates a digital model of the user's feet.

Step 200: Printing a model of the user's feet. The 3D printer 20 receives the digital model of the user's feet from the 3D scanner 10, and prints a physical model of the user's feet based on the digital model, using materials that simulate the exact softness or stiffness, size, texture, bones, skin, and muscles of the user's feet.

Step 300: Fitting the new shoes to the model. The motion simulator 30 receives the physical model of the user's feet from the 3D printer 20, and fits the new shoes to the model of the user's feet.

Step 400: Simulating the user's motions on the model with the new shoes. The motion simulator 30 simulates the user's motions on the model with the new shoes, such as running, playing, tennis, skiing, skating, etc., depending on the type and purpose of the new shoes. The motion simulator 30 can adjust the speed, intensity, duration, and frequency of the simulation according to the user's preferences or instructions.

Step 500: Breaking in the new shoes. The simulation of the user's motions on the model with the new shoes causes the new shoes to gradually adapt to the shape, size, and texture of the user's feet, and thus break in the new shoes for the user.

Step 600: Removing the new shoes from the model. After the simulation is completed, the motion simulator 30 removes the new shoes from the model of the user's feet, and the user can wear the new shoes that are more comfortable and suitable for his or her feet.

A device for breaking in new shoes using a 3D model of a user's feet, comprising:
a motion controller configured to control the 3D model of the user's feet, and simulate the user's motions on the model with the new shoes while physically breaking in the new shoes.

A 3D printer configured to print a physical model of the user's feet based on the digital model, using materials that simulate the exact softness or stiffness, size, texture, bones, skin, and muscles of the user's feet.

Wherein the 3D model is a 3D printed model.

Wherein the 3D scanner is a laser scanner, a structured light scanner, a photogrammetry scanner, or any combination thereof.

A 3D scanner configured to scan the user's feet and generate a digital model of the user's feet;

Wherein the 3D printer is a fused deposition modeling (FDM) printer, a stereolithography (SLA) printer, a selective laser sintering (SLS) printer, or any combination thereof.

Wherein the motion simulator is a treadmill, a bike, a ski machine, a skate machine, or any combination thereof.

Wherein the motion simulator is configured to adjust the speed, intensity, duration, and frequency of the simulation according to the user's preferences or instructions.

A method for breaking in new shoes using a 3D-printed model of a user's feet, comprising:
scanning the user's feet and generating a digital model of the user's feet;
printing a physical model of the user's feet based on the digital model, using materials that simulate the exact softness or stiffness, size, texture, bones, skin, and muscles of the user's feet;
fitting the new shoes to the model of the user's feet;
simulating the user's motions on the model with the new shoes; and
breaking in the new shoes for the user.

The method further comprising:
removing the new shoes from the model of the user's feet.

Wherein the scanning, printing, fitting, simulating, and breaking in are performed by a device comprising a 3D scanner, a 3D printer, and a motion simulator.

Wherein the 3D scanner is a laser scanner, a structured light scanner, a photogrammetry scanner, or any combination thereof.

Wherein the 3D printer is a fused deposition modeling (FDM) printer, a stereolithography (SLA) printer, a selective laser sintering (SLS) printer, or any combination thereof.

Wherein the motion simulator is a treadmill, a bike, a ski machine, a skate machine, or any combination thereof.

Specifically, the present application introduces an apparatus configured to break in footwear or sportswear, comprising:
a three-dimensional model of a user's feet or body based on scanning or molding; wherein the three-dimensional model comprises a material configured to mimic biomechanical properties of the user's feet or body;
a robotic motion simulator configured to simulate user-specific movements to break in the footwear or sportswear; and
a controller configured to customize break-in protocols based on user-specific parameters, to thereby break in the footwear or sportswear emulating a process of the user's wearing the footwear or sportswear to break in without user discomfort while optimizing fit of the footwear or sportswear.

In some embodiments, the scanning or molding comprises 3D scanning or photogrammetry. The three-dimensional model captures anatomical features including arch height, toe structure, and skin texture. The material used in the model substantially replicates flexibility and thermal characteristics of the user's feet or body.

Optionally, the robotic motion simulator is configured to substantially replicate human motions including walking, running, and sport-specific actions. The controller is configured to adjust simulation parameters based on user-specific data including weight distribution, gait analysis, and activity type.

A method for breaking in footwear or sportswear is disclosed and comprises:
generating a 3D model of a user's feet or body based on scanning or molding; wherein the three-dimensional model comprises a material configured to mimic biomechanical properties of the user's feet or body;
fitting the footwear or sportswear onto the 3D model;
simulating user-specific movements with a robotic motion simulator to break in the footwear or sportswear; and
customizing the break-in protocol based on user-specific parameters to reduce user discomfort and optimize fit.

Optionally, the 3D model captures anatomical features including arch height, toe structure, and skin texture; the material selection includes emulating flexibility and thermal characteristics of the user's feet; the robotic motion simulator substantially replicates user-specific movements including walking, running, and sport-specific actions; the break-in protocol is customized based on user-specific data including weight distribution, gait analysis, and activity type.

In some embodiments, a system for pre-conditioning footwear and sportswear comprises:
a 3D model creator module configured to generate a detailed model of a user's feet or body;
a material emulator configured to selecting materials that mimic the user's biomechanical properties;
a robotic motion simulator configured to simulate user-specific movements; and
a controller configured to customize break-in protocols,
wherein the system is configured to enhance fit and comfort of the footwear or sportswear for the user.

Optionally, the 3D model includes anatomical features including arch height, toe structure, and skin texture; the material emulator selects materials that substantially replicate flexibility and thermal characteristics of the user's feet or body; the robotic motion simulator is configured for user-specific movements including walking, running, and sport-specific actions; the controller is configured to adjust simulation parameters based on user-specific data including such as weight distribution, gait analysis, and activity type.

Optionally, the system further comprises a coupling device configured to couple two moving bodies.

In some embodiments, the coupling device comprises a first wearable for fitting into the first moving body, a second wearable for fitting into the second moving body; a substantially rigid portion configured conduct push and pull forces between the first moving body and the second moving body; a first coupler and a second coupler respectively coupling the first moving body and the second moving body respectively with the substantially rigid portion and configured to be partially flexible.

In some embodiments, the first coupler and the second coupler are configured to allow relative movement between the first moving body and second moving body while provide increasing resistance when the relative movement increases, to thereby prevent one of the first moving body and the second moving body falling.

Optionally, the resistance includes a rotational resistance to prevent one of the first moving body and the second moving body falling sideways.

### BRIEF DESCRIPTION OF THE DRAWINGS

FIG. 1 Illustrates the 3D foot model simulation from multiple angles, revealing its internal structure. The model is covered with a material that mimics human muscles and skin, enhancing realism in movement simulation.

FIG. 2 Illustrates how the 3D foot model simulates the customer's movement in various positions.

FIG. 3 illustrates various foot conditions and abnormalities, providing a comprehensive overview of structural issues that can affect footwear comfort and fit.

FIG. 4 Illustrates how the 3D foot model can be equipped with sensors at various positions to measure pressure distribution. These sensors help assess comfort levels and aid in reducing strain, optimizing the design for improved support and therapeutic benefits.

FIG. 5 illustrates the process of creating a 3D-printed artificial foot and highlights the internal structural components and modular, replaceable elements.

FIG. 6 illustrates a mechanical system designed to break in new shoes using a custom 3D-modeled foot.

FIG. 7 Illustrates a robot with detachable, 3D-modeled feet walking on a flat surface, or running, or climbing stairs, simulating the daily routines of customers.

FIG. 8 Illustrates personalized footwear creation, from foot data collection (uploads or 3D scanning) to AI-driven modeling, custom footwear creation (3D printing or modular assembly), and customer feedback for refinement.

FIG. 9 illustrates a 3D Foot Measurement System, which integrates both hardware and software components to efficiently scan, process, and transmit foot measurement data.

FIG. 10. illustrates a system creating the 3D model of a foot using foot images taken from different angles.

FIG. 11 is a comprehensive perspective view of the walking assistance device in a representative in-use configuration, clearly and visually illustrating a first individual (typically and preferentially the assisting person) effectively and efficiently assisting a second individual (typically and preferentially the assisted person) during a typical ambulation scenario, thereby visually highlighting the practical functional application of the device in a realistic and representative real-world usage context.

FIG. 12 is a comprehensive perspective view of the first holder (specifically in a harness embodiment), meticulously showcasing its ergonomic design features, adjustable straps and buckles, strategically positioned attachment points for the coupler, and integrated padding elements, thereby emphasizing the key design features that contribute to optimal user comfort, secure fit, and ease of use for the assisting individual.

FIG. 13 is a highly detailed and enlarged view of the coupler component, which is the core functional element of the invention, specifically and meticulously focusing on and clearly delineating the substantially rigid middle portion, which is primarily responsible for efficient and direct force transfer, and the strategically positioned flexible end portions, which are ingeniously designed to accommodate relative movement, enhance user comfort, and ensure biomechanical compatibility during walking.

FIG. 14 is a revealing cross-sectional view of the middle part of the rigid pole which has a spring to connect two poles to provide a range of movement forward and backward, meanwhile the force from both individuals can be transferred and buffered.

FIG. 15 is a schematic diagram of a travel-assist device according to some other embodiments.

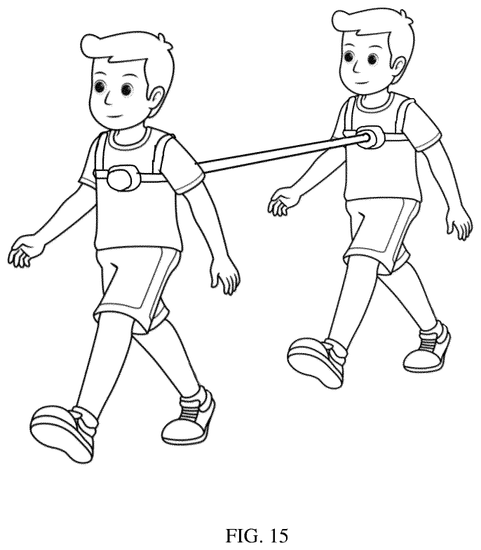

FIG. 16 is a schematic diagram of the travel-assist device illustrating a rotational resistance between the couplers to prevent a sideway falling of one of the hikers.

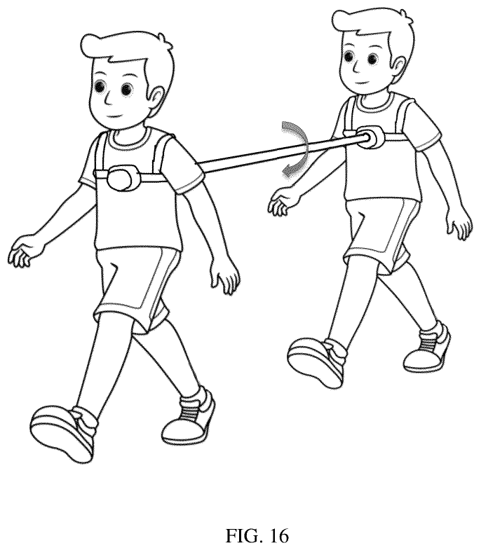

### DETAILED DESCRIPTION

The issue of breaking in new shoes is a common challenge many people encounter, as new footwear often needs time to adapt to the shape of the wearer's feet, leading to discomfort during initial use. New shoes can cause blisters and soreness, so it's important to gradually wear them in. Traditional methods for breaking in shoes include wearing thick socks or using shoe stretchers, which can be uncomfortable and cause blisters and sore spots during the process.

To minimize discomfort, it's advisable to wear the shoes for short periods initially and gradually increase the duration. Additionally, applying moleskin or blister pads to sensitive areas can help protect the skin. Another method people used is to gently bend and flex the shoes with your hands to soften the material. Some people also try using a hairdryer to warm up tight areas, then walk around in the shoes while they are still warm to help them mold to your feet. However, those methods may not work for all types of shoes or materials.

This disclosure includes a novel approach utilizing 3D scanning and then 3D printing technologies or other advanced manufacturing techniques to create an accurate replica of an individual's foot. This replica foot then can be used to produce custom-fit shoes that perfectly match the unique contours and dimensions of the wearer's feet.

This disclosure also includes an automated shoe break in system that help the customer achieve optimal comfort by simulating the natural wear process using the replica foot on the new shoes. The system simulate the natural wearing and activity of the human to break in the shoes, ensuring optimal comfort and fit from the first use. This method aims to reduce the discomfort associated with ill-fitting shoes and shorten the often painful break-in period typically required for new footwear. Additionally, the system can be customized to mimic specific activities, such as walking, running, or hiking, to tailor the break-in process to the user's lifestyle. In addition, smart sensors can be integrated into replica foot to monitor and provide real-time feedback during the break in process.

The personalized approach enabled by this technology offers enhanced comfort and a quicker break-in period, which is especially beneficial for individuals with sensitive feet or those needing specialized footwear due to medical conditions, unique foot shapes, or specific lifestyle needs. This includes athletes, people with foot deformities, or anyone who finds standard shoe sizes and shapes uncomfortable.

As technology advances and the costs of 3D printing decrease, 3D printed foot replicas could become a more feasible and appealing option for consumers seeking a personalized and comfortable shoe break-in experience. This disclosure has the potential to transform the footwear industry by providing tailored solutions that meet diverse consumer needs, leading to greater satisfaction and improved foot health. Additionally, it could reduce waste by enabling on-demand production and customization, minimizing the need for mass-produced inventory, and thus significantly reducing the environmental impact of the footwear industry in line with growing consumer demand for sustainable practices.

This disclosure also addresses challenges that hinder the widespread adoption of these technologies, such as cost barriers, limited access to 3D scanning equipment, and the need for specialized knowledge to operate the technology effectively. Concerns about the durability and longevity of 3D-printed materials compared to traditional shoe manufacturing methods are also considered. Overcoming these challenges may involve developing more affordable scanning and printing solutions, increasing public awareness and education about the benefits of custom-fit footwear, and improving 3D printing materials to meet consumer durability standards.

Additionally, this disclosure tackles the issue of mass production by introducing a modular design approach. The foot structure is divided into multiple components, which can be independently manufactured and assembled. Each component may or may not correspond to the actual human foot bone structure. Various sizes and materials can be used for each component to accommodate different needs and preferences. Once the customer provides a 3D model of their foot, a computer algorithm divides the foot into components of different sizes and materials, and the final replica foot is assembled from these components.

For customers without access to 3D scanning technology, instructions are provided for taking photos of their feet from different angles, along with data from traditional measurement methods. A computer algorithm is used to reconstruct the 3D foot model from these images and measurements. Alternatively, customers can use a molding kit to create a physical impression of their foot, which can be sent back for analysis. This flexibility allows for customization and scalability in production, ensuring the final product is tailored to individual requirements while maintaining efficiency in manufacturing processes. The issue of breaking in new shoes is a common challenge many people encounter, as new footwear often needs time to adapt to the shape of the wearer's feet, leading to discomfort during initial use. Traditional methods for breaking in shoes include wearing thick socks or using shoe stretchers, which can be uncomfortable and cause blisters and sore spots.

The disclosure pertains to the field of footwear, specifically to a device and method for breaking in and custom-fitting new shoes to the individual's foot dimensions, texture, and biomechanical characteristics.

New shoes, including but not limited to sports footwear such as ski boots, hiking shoes, tennis shoes, and other specialized sports shoes, often cause discomfort or injury due to inadequate fit to the wearer's feet. Traditional methods for breaking in shoes are time-consuming, potentially damaging to the shoes, and do not always result in a perfect fit.

The disclosure introduces a novel device and method for custom-fitting new shoes to an individual's feet. It involves creating a detailed 3D model of the person's feet, including dimensions, softness or stiffness, internal structures (bones, muscles), and skin texture. This model is then used to simulate real-life motions specific to the intended use of the shoes (e.g., running, skiing, playing tennis) in a controlled environment, thereby adapting the shoes to the exact contours and biomechanical properties of the user's feet without requiring the user to wear them during the break-in period.

3D Foot Model Creation Unit: Utilizes scanning technology to capture precise measurements and material characteristics of an individual's feet, including softness, stiffness, and internal anatomical features.

Material Simulation Module: Fabricates the 3D foot model using advanced materials that closely mimic the physical properties of human foot tissues.

Motion Simulation System: Equipped to place the shoe on the 3D foot model and subject it to various motions and stresses that replicate actual human activities (running, jumping, skiing, etc.), ensuring the shoe adapts to the foot model.

### Method of Operation:

Step 1: Scanning the user's feet to obtain detailed measurements and characteristics.
Step 2: Creating a precise 3D printed model of the feet using materials selected based on the scanned data to replicate the softness, stiffness, texture, and internal structures of the user's feet.
Step 3: Fitting the new shoes onto the 3D foot model.
Step 4: Activating the motion simulation system to subject the shoes and foot model to a series of movements and stresses that mimic real-life use, varying by the specific requirements of the footwear (e.g., sports-specific motions for athletic shoes).
Step 5: Monitoring and adjusting the process as necessary to ensure optimal fit and comfort are achieved.

A device for custom-fitting footwear, comprising a 3D foot model creation unit, a material simulation module, and a motion simulation system.

A method for custom-fitting new shoes to an individual's feet, involving creating a 3D model of the feet, fabricating the model with specific material properties, fitting the shoes to the model, and simulating real-life motions to adapt the shoes to the model.

Where the motion simulation system is programmed to replicate various specific activities relevant to the intended use of the footwear.

Use of a 3D printed model replicating the exact softness, stiffness, texture, and anatomical features of an individual's feet for the purpose of breaking in new shoes.

A device and method for customizing the fit of new shoes to an individual's feet without the wearer having to break them in. The disclosure involves scanning the user's feet, creating a detailed 3D model of the feet, and using this model to simulate the natural movements and stresses experienced by the shoes during actual use. This process adapts the shoes to the unique contours and biomechanical properties of the user's feet, ensuring optimal fit and comfort.

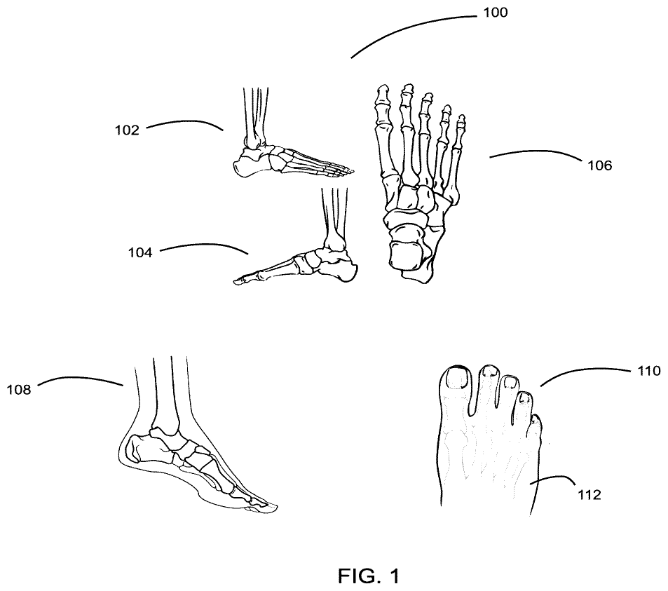

FIG. 1 illustrates a three-dimensional foot model simulation from various perspectives, illustrating its internal structure. The foot model is enveloped in a material designed to replicate the properties of human muscles and skin, thereby facilitating realistic movement simulation. The illustration of the 3D foot model 100 provides a detailed representation of the model's design, which is integral to the disclosure's operation. The right side view of the structure, denoted as 102 and 104, demonstrates the anatomical precision of the model, ensuring that it closely resembles the user's foot in terms of shape and dimensions. The top view of the structure, identified as 106, further underscores the model's intricate construction, which is necessary for accurate simulation of foot dynamics.

The side view of the 3D foot model, covered with simulated human muscle material 108, illustrates the model's capability to replicate the biomechanical properties of a human foot. This feature is integral to the disclosure's function of breaking in footwear by simulating actual movements. The top view of the foot model, covered with material analogous to human muscle and skin 110, highlights the model's ability to emulate the tactile and structural characteristics of a human foot, which is important for achieving a customized fit.

The material that mimics the strength and tactile properties of human muscle and skin 112 is a component of the disclosure, enabling the 3D model to provide realistic feedback during the break-in process. This material selection is designed to replicate the flexibility and thermal properties of the user's feet, ensuring that the footwear adapts to the user's specific foot structure over time.

The system for breaking in footwear and sportswear comprises several modules, each serving a distinct function. The 3D model creation module is configured to generate a three-dimensional model of a user's feet or body using scanning technologies such as 3D scanning or photogrammetry. This module captures anatomical features such as arch height, toe structure, and skin texture, providing a detailed representation of the user's foot. In addition, sensors that detect pressure could be integrated to gather data, how the feet will feel comfortable wearing a pair of shoes. A virtual try-on module allows users to visualize how the footwear will look and feel, enabling adjustments before the final product is manufactured.

The material emulation module is configured to select materials for the 3D model that mimic the biomechanical properties of the user's feet or body. This includes replicating the flexibility and thermal characteristics, which are necessary for ensuring that the footwear conforms to the user's foot shape during the break-in process. The robotic motion simulator is configured to simulate user-specific movements, such as walking, running, and sport-specific actions, to break in the footwear and sportswear effectively.

The control module is configured to customize break-in protocols based on user-specific parameters, such as weight distribution, gait analysis, and activity type. This customization ensures that the break-in process is tailored to the individual's requirements, reducing discomfort and optimizing the fit of the footwear and sportswear.

The disclosure's applications include orthopedic rehabilitation, shoe manufacturing, and virtual shoe shopping. In orthopedic rehabilitation, the system can assist in recovery by simulating therapeutic movements and adjusting footwear to accommodate healing feet. For shoe manufacturers, the system provides a method to test and optimize new shoe designs for comfort and performance, offering data for design improvements.

In virtual shoe shopping, the disclosure enables online shoppers to virtually try on shoes for a better fit, with the option to have shoes pre-broken in before delivery. This enhances the online shopping experience by reducing the likelihood of returns due to poor fit. Additionally, the system can assist athletes in fine-tuning their footwear for optimal performance, reducing the risk of injury and enhancing comfort.

Potential applications of this disclosure include orthopedic rehabilitation, where the system can aid in recovery by simulating therapeutic movements. Shoe manufacturers can use the system to test and optimize new shoe designs for comfort and performance, providing valuable data for design improvements. The disclosure also has applications in virtual shoe shopping, allowing online shoppers to virtually try on shoes for a better fit, reducing return rates and enhancing customer satisfaction. Additionally, athletes can use the system to fine-tune their footwear for optimal performance, with potential applications in professional sports training.

The advantages of this disclosure include a personalized fit that is customized to the individual's foot shape, reducing the need for trial and error in shoe selection. The system's efficiency in reducing break-in time compared to traditional methods is a benefit, as it actively modifies the shoe structure to conform to the user's foot. This optimized performance ensures that footwear is broken in under real-world conditions, enhancing athletic performance and comfort.

Furthermore, the disclosure's durability advantage prevents over-wearing or fabric overstretching, extending the product lifespan by ensuring a fit from the start. By focusing on dynamic adaptation and real-time feedback, this disclosure provides an advancement over existing technologies in the field of footwear customization, offering a comprehensive approach to breaking in shoes and sportswear.

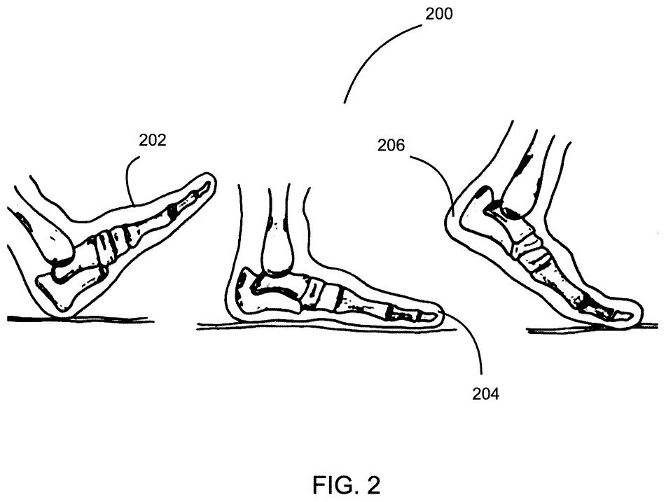

FIG. 2 illustrates the 3D foot model movement simulation, showcasing how to replicate a customer's movements in various positions. The labeled components include the three positions of model feet 200, which simulate walking, the foot lifting up 202, the foot standing on a flat surface 204, and the heel of the model feet lifting up 206. These components collectively demonstrate the dynamic capabilities of the system in mimicking real-life foot movements, which helps for the effective break-in of footwear.

The three positions of model feet 200 are designed to simulate the natural walking motion of a human foot. This simulation can be achieved through a series of programmed movements that replicate the heel-to-toe transition experienced during walking. By accurately mimicking this motion, the system ensures that the footwear adapts to the user's foot shape and movement patterns, thereby enhancing comfort and fit. This feature is integral to the disclosure's ability to provide a personalized break-in process for new shoes.

The foot lifting up 202 is a component of the simulation process, as it replicates the upward motion of the foot during walking or running. This movement is for testing the flexibility and adaptability of the shoe material, ensuring that it can accommodate the natural lift of the foot without causing discomfort. The ability to simulate this motion allows the system to identify potential pressure points and adjust the shoe's fit accordingly, thereby reducing the risk of blisters or sore feet.

The foot standing on a flat surface 204 represents the static phase of the walking cycle, where the foot is fully in contact with the ground. This position is for assessing the shoe's support and stability, as it allows the system to evaluate how well the shoe distributes weight across the foot. By simulating this position, the system can ensure that the shoe provides adequate support and comfort during prolonged periods of standing or walking.

The heel of the model feet lifting up 206 simulates the final phase of the walking cycle, where the heel lifts off the ground as the foot prepares to take the next step. This movement is for testing the shoe's heel support and flexibility, ensuring that it can accommodate the natural lift of the heel without causing discomfort. By accurately replicating this motion, the system can optimize the shoe's fit and performance, enhancing the overall user experience.

The robotic motion simulator, is configured to replicate complex human motions, including walking, running, and sport-specific actions. This capability is for the disclosure's application in breaking in specialized sports footwear, such as ski boots or tennis shoes, which require precise adaptation to the user's unique movement patterns. By simulating these complex motions, the system can ensure that the footwear provides optimal performance and comfort in real-world scenarios.

The 3D model creation module is configured to generate a detailed three-dimensional model of a user's feet using advanced scanning technologies. This model captures anatomical features such as arch height, toe structure, and skin texture, providing a comprehensive representation of the user's foot. The accuracy of this model helps for the success of the break-in process, as it ensures that the footwear conforms precisely to the user's unique foot shape.

The material emulation module is responsible for selecting materials for the 3D model that mimic the biomechanical properties of the user's feet. This includes replicating the flexibility, stiffness, and thermal characteristics of the foot, ensuring that the model behaves like a real foot during the simulation process. By accurately emulating these properties, the system can provide a realistic break-in experience that closely mirrors the conditions experienced by the user during actual wear.

The control module is configured to customize break-in protocols based on user-specific parameters, such as weight distribution, gait analysis, and activity type. This customization ensures that the break-in process is tailored to the individual needs of the user, optimizing the fit and comfort of the footwear. By adjusting the simulation parameters in real-time, the system can dynamically respond to feedback from the model, enhancing the effectiveness of the break-in process.

Potential applications of this disclosure include orthopedic rehabilitation, where the system can aid in recovery by simulating therapeutic movements and adjusting footwear to accommodate healing feet. Shoe manufacturers can also benefit from this technology by testing and optimizing new shoe designs for comfort and performance, providing valuable data for design improvements. Additionally, the disclosure can enhance virtual shoe shopping experiences by allowing online shoppers to virtually try on shoes for a better fit, with the option to have shoes pre-broken in before delivery.

The advantages of this disclosure include a personalized fit, which reduces the need for trial and error in shoe selection, and increased efficiency, as it significantly reduces break-in time compared to traditional methods. The system also optimizes performance by ensuring footwear is broken in under real-world conditions, enhancing athletic performance and comfort. Furthermore, it extends product lifespan by preventing over-wearing or fabric overstretching, ensuring a perfect fit from the start.

This disclosure provides a comprehensive approach to breaking in shoes and sportswear, ensuring both comfort and performance. By leveraging 3D modeling and robotic simulation, it adapts new products to the user's unique physical characteristics, reducing discomfort and enhancing the overall user experience. The focus on dynamic adaptation and real-time feedback represents a significant advancement over existing technologies in the field of footwear customization.

Common foot ailments such as bunions, gout, and plantar fasciitis can lead to pain, swelling, and walking difficulties for many people. These issues can become particularly severe when someone buys a new pair of shoes that don't fit well, resulting in increased pressure and discomfort.

Bunions (hallux valgus) are a foot deformity characterized by a bony bump forming at the base of the big toe, often causing pain, swelling, and difficulty wearing shoes. Bunionettes (tailor's bunion) are a similar condition occurring on the outside of the foot at the base of the little toe, leading to discomfort, redness, and footwear challenges. Treatment options for both conditions include wearing wider shoes, using orthotic inserts, applying ice to reduce swelling, and taking over-the-counter pain relievers. In severe cases, surgery may be necessary to correct the deformity and relieve symptoms.

Gout is a form of arthritis characterized by sudden, severe attacks of pain, redness, and tenderness in the joints, often affecting the big toe. It occurs due to the accumulation of urate crystals, which form when there is high uric acid in the blood. Similar as bunion, gout can cause significant discomfort and swelling in the affected area.

Preventive measures of those common foot declasses include choosing footwear that fits well and provides adequate support, maintaining a healthy weight to reduce pressure on the feet, and performing exercises to strengthen the muscles in the feet. Early intervention can help manage symptoms and prevent the progression of the deformity. After the patient purchasing a new pair of shoes, the automated shoe break-in system, will help ensure comfort and reduce the risk of blisters or discomfort. This system gradually adjusts the shoes to the shape of the feet, making them more comfortable for extended wear.

When buying new shoes, patients should choose styles with a wide toe box to comfortably accommodate bunions or bunionettes. Shoes that offer good arch support and cushioning can help alleviate pressure on affected areas. Alternatively, patients can use a custom foot model with sensors, which illustrated in this disclosure to ensure an accurate fit. This technology measures pressure points and identifies areas that need extra space or support, aiding in the selection of shoes that provide optimal comfort and reduce irritation of the condition.

If perfectly fitting shoes are not immediately available, patients can purchase new shoes and utilize the shoe breaking in system described in disclosure to gradually break them in. This method involves using the foot model to wear the shoes for a specified duration. The system simulates normal human activities such as walking, running, and standing, allowing the shoe material to stretch and adapt to the foot's shape without causing discomfort. The shoe breaking process concludes when the sensors on the model feet indicate that the shoes have adjusted to the desired fit. This ensures that the shoes are comfortable and supportive before the patient wears them for long periods. By employing this method, patients can avoid the pain and discomfort often associated with breaking in new shoes, especially when dealing with foot conditions like bunions.

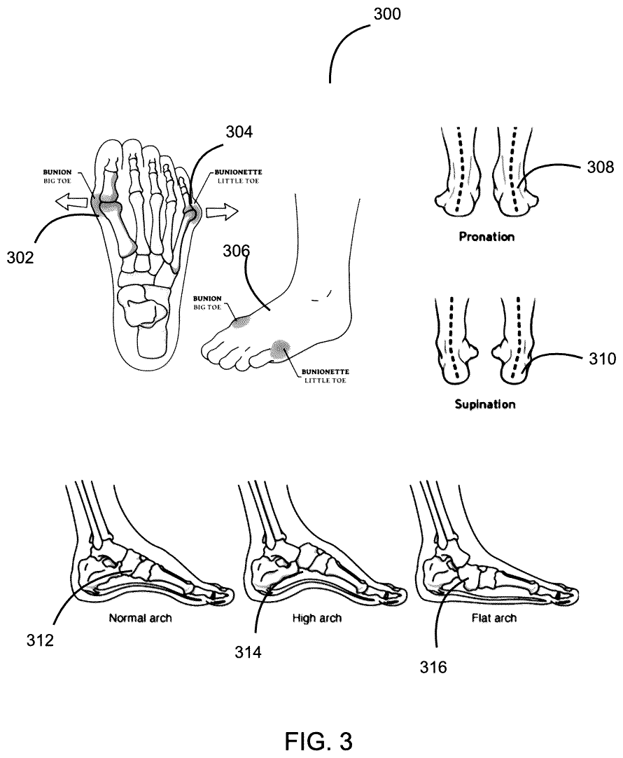

FIG. 3 illustrates various foot conditions and abnormalities, providing a comprehensive overview of structural issues that can affect footwear comfort and fit. The labeled objects within this figure include bunions (hallux valgus) 302, bunionettes (tailor's bunion) 304, and their anatomical locations 306. Additionally, the figure highlights conditions such as pronation 308, supination 310, normal arch 312, high arch (cavus foot) 314, and flat arch (fallen arch, pes planus) 316. These conditions are common in diagnosing foot-related issues and customizing footwear solutions to enhance comfort and support.

The foot-related conditions overview 300 provides a foundational understanding of how various structural abnormalities can impact foot health and comfort. By identifying these conditions, the disclosure can tailor the 3D model of the user's feet to account for specific abnormalities, ensuring that the footwear is broken in to accommodate these unique features. This customization is crucial for users with specific foot conditions, as it allows for a more personalized and comfortable fit.

The bunion (hallux valgus) 302 and bunionette (tailor's bunion) 304 are common foot deformities that can cause significant discomfort when wearing new shoes. The disclosure addresses these issues by incorporating the anatomical location of bunions and bunionettes 306 into the 3D model. By doing so, the system can simulate the pressure and friction points that these conditions typically experience, allowing the footwear to adapt and reduce discomfort over time.

Pronation 308 and supination 310 are conditions related to the rolling motion of the foot during walking or running. Pronation involves excessive inward rolling, while supination involves outward rolling, often leading to instability. The disclosure's control module is configured to adjust simulation parameters based on user-specific data, such as weight distribution and gait analysis, to accommodate these conditions. This ensures that the footwear is broken in to support the user's natural foot motion, enhancing stability and comfort.

The normal arch 312, high arch (cavus foot) 314, and flat arch (fallen arch, pes planus) 316 represent different arch types that can affect foot biomechanics. The flat arch can lead to overpronation, which may cause stress on the ankles and knees. Proper support through orthotics or supportive footwear can help alleviate discomfort and improve alignment. The high arch can lead to underpronation, resulting in less shock absorption and increased pressure on the heel and ball of the foot. This can cause issues such as plantar fasciitis or stress fractures. Using cushioned insoles or supportive shoes can help distribute pressure more evenly and provide better shock absorption.

The 3D model creation module captures these anatomical features, allowing the material emulation module to select appropriate materials that mimic the user's arch characteristics. This customization ensures that the footwear provides optimal support and reduces strain on muscles and ligaments, particularly for users with high or flat arches.

The disclosed system's ability to create a personalized 3D model of the user's feet, combined with the robotic motion simulator's capability to mimic real-life movements, offers significant advantages in terms of comfort, fit, and performance. By addressing specific foot conditions and structural features, the system enhances the overall user experience, making it particularly beneficial for individuals with unique foot anatomies or those requiring specialized footwear solutions. Potential applications include orthopedic rehabilitation, shoe manufacturing, virtual shoe shopping, and athletic performance optimization, highlighting the disclosure's versatility and broad applicability.

The system's control module is configured to adjust simulation parameters based on user-specific data, such as weight distribution, gait analysis, and activity type, as described in claim 6. This feature allows the system to dynamically adapt the break-in process to the user's unique foot conditions and movement patterns. By doing so, the disclosure not only enhances comfort but also optimizes the fit and performance of the footwear.

The disclosure's potential applications extend beyond individual users to include orthopedic rehabilitation, where the system can aid in recovery by simulating therapeutic movements and adjusting footwear to accommodate healing feet. Shoe manufacturers can also benefit from this technology by testing and optimizing new shoe designs for comfort and performance, providing valuable data for design improvements. Additionally, virtual shoe shopping can be enhanced by allowing online shoppers to virtually try on shoes for a better fit, with the option to have shoes pre-broken in before delivery.

This disclosure provides a comprehensive approach to breaking in shoes and sportswear, ensuring both comfort and performance. By leveraging 3D modeling and robotic simulation, the system adapts new products to the user's unique physical characteristics, reducing discomfort and enhancing the overall user experience. The focus on dynamic adaptation and real-time feedback offers a significant advancement over existing technologies in the field of footwear customization.

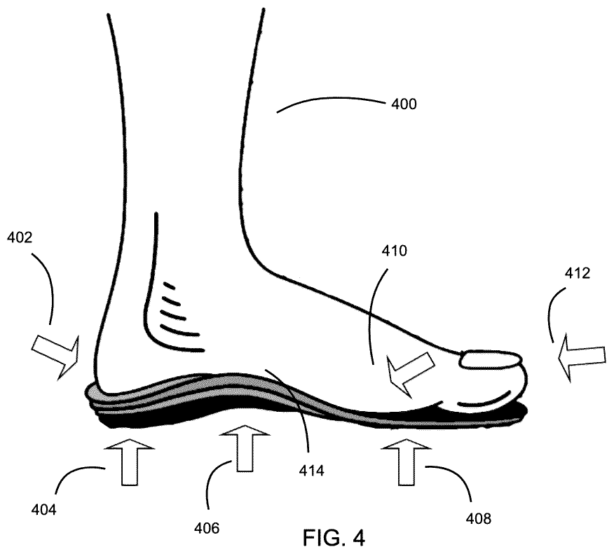

FIG. 4 illustrates a sensor-equipped 3D foot model designed to optimize the break-in process of footwear by measuring pressure distribution across various foot regions. The 3D model foot 400 is equipped with multiple sensors strategically placed to capture detailed pressure data. These sensors help to understand how pressure is distributed across the replica foot during various activities, which can inform adjustments to the shoe design to enhance comfort and reduce strain.

These sensors are integral to assessing comfort levels and reducing strain, thereby optimizing the design for improved support and therapeutic benefits. Other than pressure sensors, friction sensors are also integrated into the model to measure the shear forces experienced by the foot. This data help to identify hotspot areas where friction may lead to discomfort or injury to the feet. By analyzing both pressure and friction data, the shoe break in system that simulate human movement may stop and notify the user that the shoe is properly adjusted and ready for use.

The sensor in the heel position 402 is configured to measure the pressure exerted on the heel area during simulated movements. This sensor provides data on how the heel of the shoe interacts with the foot, which helps for adjusting the shoe's fit and cushioning to prevent discomfort and potential injuries such as heel spurs.

The sensor in the rear end of the sole 404 is positioned to capture pressure data from the back part of the foot's sole. This sensor helps in understanding the distribution of weight and pressure during activities such as walking or running, allowing for adjustments in the shoe's design to enhance stability and support.

The sensor in the arch position 406 is placed to monitor the pressure on the arch of the foot. This data helps customizing the arch support in the shoe, which can alleviate common foot problems such as plantar fasciitis and flat feet. The arch of the foot 414 is a critical area that requires precise support to maintain foot health and comfort.

The sensor in the front end of the sole 408 measures the pressure at the forefoot area. This sensor is vital for ensuring that the shoe provides adequate cushioning and flexibility in the forefoot, which is essential for activities that involve significant toe-off motion, such as running and jumping.

The sensor 410 is located on the side of the 3D model foot where a bunion could develop. This sensor is particularly important for detecting pressure points or hotspot that could lead to the formation of bunions or the discomfort associated with bunions or other foot-related issues. It helps in monitoring and analyzing pressure distribution. By monitoring these areas, the sensor can provide valuable data to help take extra step to fitting the new shoes to prevent or alleviate pain, ensuring better foot health and comfort. By identifying these pressure points, the system can modify the shoe's fit to alleviate pressure and prevent bunion development.

The sensor in the toe position 412 captures pressure data from the toes, which ensures that the shoe allows for natural toe splay and movement. This sensor helps in designing the toe box of the shoe to prevent issues such as blisters and toenail damage.

The arch of the foot 414 is an area for maintaining balance and distributing weight evenly across the foot. The sensors in this area provide valuable data on how the arch interacts with the shoe during various activities. This information can be used to tailor the shoe's design for optimal arch support and comfort.

The sensors could feed data into a control module that adjusts simulation parameters based on user-specific data such as weight distribution, gait analysis, and activity type. This control module is integral to customizing the break-in process for each user, ensuring that the shoe adapts to the unique characteristics of the user's foot and movement patterns. By incorporating real-time feedback from the sensors, the system can dynamically adjust replica foot to change the shoe's internal structure to enhance comfort and performance.

The disclosure described herein provides a comprehensive system for breaking in footwear and sportswear using a sensor equipped 3D model of a user's feet. The method involves generating a detailed 3D model using advanced scanning technologies, selecting materials that emulate the biomechanical properties of the user's feet, and fitting the footwear onto this model. A robotic motion simulator is then used to simulate user-specific movements, allowing the footwear to adapt to the user's foot shape over time.

The 3D model creation module is configured to generate a three-dimensional model of a user's feet or body, capturing anatomical features such as arch height, toe structure, and skin texture. This module ensures that the model accurately reflects the user's unique foot characteristics, which is crucial for achieving a personalized fit.

The material emulation module selects materials that replicate the flexibility and thermal characteristics of the user's feet. This module ensures that the 3D model behaves like a real foot, providing realistic feedback during the break-in process.

The robotic motion simulator is configured to replicate complex human motions, including walking, running, and sport-specific actions. This simulator allows the footwear to be broken in under real-world conditions, ensuring that it adapts to the user's specific movement patterns.

The control module adjusts simulation parameters based on user-specific data such as weight distribution, gait analysis, and activity type. This module customizes the break-in protocol to optimize fit and comfort, reducing the risk of discomfort and injury.

The disclosure's advantages include a personalized fit that reduces the need for trial and error in shoe selection, increased efficiency by significantly reducing break-in time, optimized performance by ensuring footwear is broken in under real-world conditions, and enhanced durability by preventing over-wearing or fabric overstretching.

Potential applications of this disclosure include orthopedic rehabilitation, where it aids in recovery by simulating therapeutic movements and adjusting footwear to accommodate healing feet. Shoe manufacturers can use the system to test and optimize new shoe designs for comfort and performance, providing valuable data for design improvements. The disclosure also facilitates virtual shoe shopping, allowing online shoppers to virtually try on shoes for a better fit, with the option to have shoes pre-broken in before delivery. Additionally, it helps athletes fine-tune their footwear for optimal performance, reducing the risk of injury and enhancing comfort.

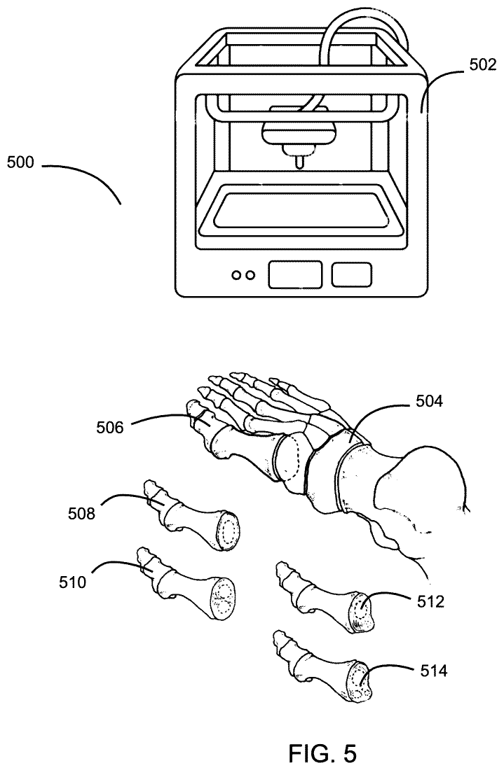

FIG. 5 illustrates the process of creating a 3D-printed artificial foot and highlights the internal structural components and modular, replaceable elements. The 3D Printing Technology for Prosthetic Foot 500 is central to this process, enabling the precise fabrication of customized prosthetic foot components. The 3D Printer 502 is configured to produce these components by layering materials to form a detailed and accurate representation of a user's foot, capturing unique anatomical features such as arch height, toe structure, and skin texture, as referenced in the claims.

There are different method to create the replica foot from the 3D model. The replica foot can be created directly by a 3D printer using silicon materials or plastic. Another approach is to design the foot in modular way, that can be assembled through components similar as the bone structure of the foot. The individual components can be printed or created separately and then assembled to form the complete replica. The completed internal structure of the foot then will be covered with silicone layer or other suitable materials to mimic the texture and appearance of the actual foot. These methods allow for mass production yet customization with precision, making them suitable for low cost production.

The Artificial Foot Structure 504 serves as the base framework for the prosthetic foot. This structure is designed to replicate the bone structure that support the overall shape and dimensions of the user's foot, providing a foundation upon which additional components can be added. The Skeletal artificial big toe 506 within the artificial foot structure is a replaceable component that mimics the function and movement of a natural big toe.

The Replaceable Big Toe 508 is a modular component that allows for adjustability and customization. This feature is particularly beneficial for simplify and reduce cost manufacturing of the foot models. Every component of the artificial foot could have interchangeable parts, common sizes of human foot are measured and standardized to ensure compatibility. When user submitted a 3D foot model, or multiple views of the user's foot, the system can generate a customized fit by selecting the appropriate components. This ensure that it is not necessary to customize based on individual customer's feet model.

Standard feet structure components can be pre-manufactured, and assembled quickly to meet specific user feet model. This approach streamlines production, reduces lead times, and minimizes costs while maintaining high-quality standards. Additionally, the modular design allows for easy repairs and upgrades, extending the lifespan of the artificial foot. The customer's feet may change over time due to factors such as weight fluctuations, aging, or medical conditions. With the modular design, users can easily replace or adjust specific components to accommodate these changes without needing a completely new prosthetic.

This adaptability not only enhances user comfort and satisfaction but also promotes sustainability by reducing waste. Meanwhile, a family can benefit from the cost savings and convenience offered by this modular system. All members of the family are not required to purchase entirely new prosthetics if adjustments are needed. Instead, they can simply update or replace individual components as necessary. This flexibility ensures that each family member can maintain a comfortable and functional fit, regardless of difference in their physical condition. Additionally, the modular system's cost-effectiveness makes it accessible to a wider range of families, allowing more people to benefit from advanced prosthetic technology without financial strain.

Similarly, the Replaceable Second Toe 510, Replaceable Third Toe 512, and Replaceable Fourth Toe 514 are swappable parts that accommodate different designs and preferences, enhancing the prosthetic foot's adaptability and user comfort.

The Replaceable Second Toe 510 is a swappable part that accommodates different designs. This component, along with the other replaceable toes, allows for a high degree of customization, ensuring that the artificial foot can accurately replicate the user's foot anatomy. This adaptability is particularly beneficial for users with unique foot shapes or specific footwear requirements, as it enables the system to provide a personalized break-in experience.

The Replaceable Third Toe 512 is an interchangeable component that offers further customization options. By allowing users to swap out toe components, the system can be tailored to accommodate various foot shapes and sizes, as well as different types of footwear. This flexibility is an advantage of the disclosure, as it ensures that the break-in process is optimized for each individual user.

The Replaceable Fourth Toe 514 is another adaptable toe module that contributes to a personalized fit. This component, like the other replaceable toes, can be adjusted to match the user's specific foot anatomy, ensuring that the artificial foot provides an accurate and comfortable fit. The modular design of the toe components is a significant innovation, as it allows for a high degree of customization and adaptability, enhancing the overall effectiveness of the shoe break-in process. However, the cost of the modular design is much lower compared to 3D printing the entire custom foot structure. By focusing on modular components, the system reduces material waste and production time, making it a cost-effective solution for personalized prosthetic and footwear applications. This approach not only benefits users by providing a tailored fit but also streamlines the manufacturing process, allowing for quicker adjustments and replacements as needed.

The disclosure's potential applications are vast, ranging from orthopedic rehabilitation to virtual shoe shopping. By providing a personalized and efficient method for breaking in footwear and sportswear, the system offers significant benefits in terms of comfort, performance, and durability. The use of 3D printing technology and modular components ensures that the system can be tailored to meet the needs of individual users, making it a versatile and valuable tool for both consumers and manufacturers.

The robotic motion simulator is configured to simulate user-specific movements, such as walking, running, and sport-specific actions. This simulation process is integral to breaking in the footwear and sportswear, allowing them to conform to the user's unique foot structure and movement patterns. The control module customizes break-in protocols based on user-specific parameters, such as weight distribution, gait analysis, and activity type, optimizing the fit and comfort of the footwear and sportswear.

Potential applications of this disclosure include orthopedic rehabilitation, where the device aids in recovery by simulating therapeutic movements and adjusting footwear to accommodate healing feet. Shoe manufacturers can utilize this technology to test and optimize new shoe designs for comfort and performance, providing valuable data for design improvements. Additionally, virtual shoe shopping can benefit from this disclosure by allowing online shoppers to virtually try on shoes for a better fit, with the option to have shoes pre-broken in before delivery.

The advantages of this disclosure are numerous. It offers a personalized fit, customized to the individual's foot shape, reducing the need for trial and error in shoe selection. The efficiency of the break-in process is significantly enhanced, reducing the time required compared to traditional methods. The optimized performance ensures that footwear is broken in under real-world conditions, enhancing athletic performance and comfort. Furthermore, the durability of the footwear is improved, preventing over-wearing or fabric overstretching, thus extending the product lifespan.

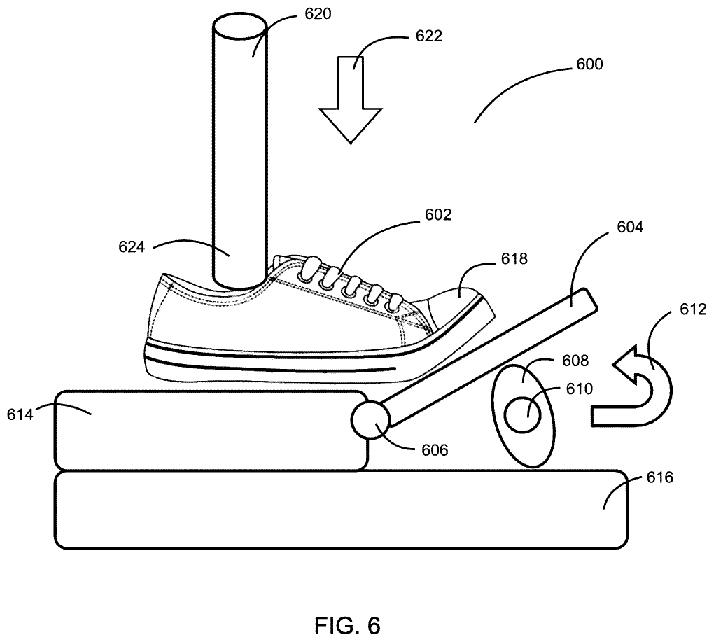

FIG. 6 illustrates a mechanical system designed to break in new shoes using a custom 3D-modeled foot. This setup is configured to simulate real-world walking conditions to flex and condition the shoe, ensuring a comfortable fit. The system comprises several components, each playing a critical role in the break-in process.

The Footwear Testing System Overview 600 provides a comprehensive setup designed to evaluate the structural durability of a shoe under simulated conditions. This system is integral to ensuring that the shoe not only fits comfortably but also maintains its structural integrity over time. By simulating various walking conditions, the system can predict how the shoe will perform in real-world scenarios, thereby enhancing its durability and user satisfaction.

The Shoe Under Test 602 is the footwear being evaluated for durability, flexibility, and structural performance. This component is central to the testing process, as it undergoes various stress tests to ensure it can withstand the rigors of everyday use. The shoe is fitted onto the 3D model foot and subjected to simulated movements that mimic real-life activities, allowing it to gradually conform to the user's foot shape.

The Bending Lever Arm 604 is a mechanism that applies force to bend the shoe at the forefoot area, simulating walking or running conditions. This component is crucial for testing the shoe's flexibility and ensuring that it can accommodate the natural movements of the foot. By applying controlled bending forces, the lever arm helps to break in the shoe, making it more comfortable for the user.

The Pivot Point/Hinge Mechanism 606 serves as the central hinge where the bending motion occurs, controlling the flexing of the shoe. This mechanism is designed to provide a realistic simulation of foot movements, ensuring that the shoe can adapt to various walking and running conditions. The hinge mechanism is adjustable, allowing for customization based on the specific requirements of the shoe being tested.

The Rotating Cam/Wheel Mechanism 608 is a cam system that applies rotational motion to repeatedly bend the shoe. This component is essential for simulating continuous movement, such as walking or running, over an extended period. The rotating cam ensures that the shoe undergoes consistent flexing, which is necessary for a thorough break-in process.

The Axle or Rotation Shaft 610 supports the rotating cam, ensuring controlled and repeatable bending forces. This component is designed to provide stability and precision during the testing process, allowing for accurate simulation of real-world conditions. The axle's robust construction ensures that it can withstand the repeated stresses of the break-in process.

The Rotational Motion Indicator 612 shows the direction of rotation applied to bend the shoe. This indicator is a vital part of the system, providing visual feedback on the testing process and ensuring that the shoe is subjected to the correct movements. By monitoring the rotational motion, operators can make necessary adjustments to optimize the break-in process.

The Base Platform (Cushioned or Rigid Support) 614 serves as the foundation of the testing apparatus, holding the shoe in place during the test. This platform is designed to provide a stable and secure base for the shoe, ensuring that it remains in the correct position throughout the testing process. The platform can be adjusted to accommodate different shoe sizes and types.

The Additional Base Layer/Support Block 616 is a structural component that reinforces the stability of the testing setup. This layer provides additional support to the base platform, ensuring that the entire system remains stable during the testing process. The support block is adjustable, allowing for customization based on the specific requirements of the shoe being tested.

The Toe Cap of the Shoe 618 is the front area of the shoe where flexing pressure is applied. This component is critical for testing the shoe's ability to accommodate the natural movements of the toes during walking or running. By applying pressure to the toe cap, the system can ensure that the shoe provides adequate support and comfort for the user.

The Vertical Pressure Rod 620 is a cylindrical component applying downward force on the shoe, mimicking weight distribution during walking. This rod is designed to simulate the pressure exerted by the foot during normal activities, ensuring that the shoe can withstand everyday use. The pressure rod is adjustable, allowing for customization based on the specific requirements of the shoe being tested.

The Force Application Indicator (Downward Arrow) 622 indicates the direction of the applied force simulating foot pressure. This indicator provides visual feedback on the testing process, ensuring that the shoe is subjected to the correct amount of pressure. By monitoring the force application, operators can make necessary adjustments to optimize the break-in process.

The bottom part of the cylindrical component 624 is attached to the heel section of the model foot, which is covered by the shoe 602. Pressure is exerted on the model foot, keeping the back of the foot stable while the forefoot is subjected to flex testing. This part is engineered to offer support and stability throughout the testing, ensuring the shoe retains its structural integrity. By stabilizing the heel section, the system can effectively replicate the natural movements of the foot.

The Footwear Durability Testing System provides a comprehensive approach to breaking in new shoes, ensuring both comfort and performance. By leveraging advanced 3D modeling and robotic simulation technologies, the system can adapt new products to the user's unique physical characteristics, reducing discomfort and enhancing the overall user experience. This disclosure offers significant advancements over existing technologies in the field of footwear customization, providing a more efficient and effective solution for breaking in new shoes.

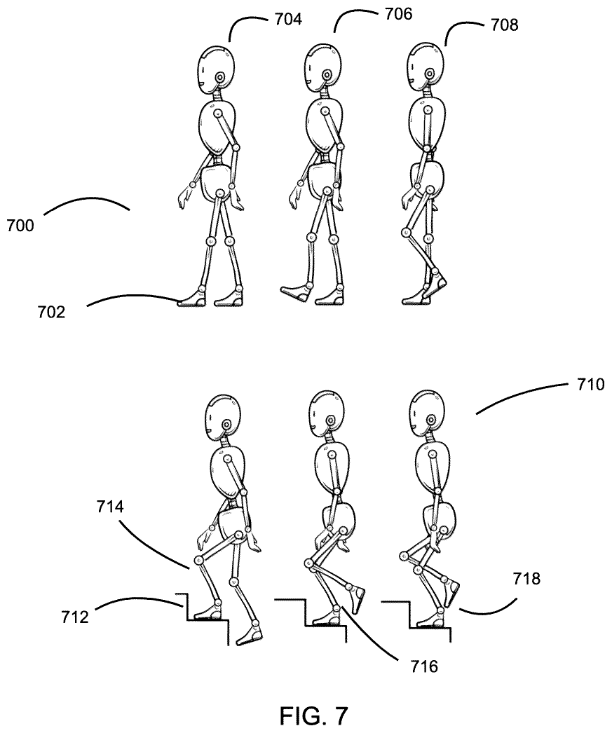

FIG. 7 illustrates a robotic simulation system designed to assist in the break-in process of new footwear using 3D-modeled feet. The system comprises a robot 700 configured to walk on a flat surface, simulating the daily routines of users. The robot's feet, labeled as 702, are detachable and consist of 3D-modeled replicas of human feet, allowing for precise emulation of user-specific foot characteristics.

The robot 700 is shown in various walking positions, including position 1 (704), where the robot has just started walking, position 2 (706), where the robot moves forward, and position 3 (708), where the robot has completed a step. These positions demonstrate the robot's ability to replicate human walking patterns, which is crucial for the effective break-in of footwear. By simulating these movements, the system ensures that the shoes adapt to the user's foot shape, reducing discomfort and enhancing fit.

In addition to walking on flat surfaces, the robot 710 is also capable of climbing stairs, as depicted in the image. The stair 712 provides a realistic environment for testing the adaptability of footwear to different terrains. The robot's stair-climbing sequence includes a start position (714), a position where one leg is lifted (716), and a position where the robot is on the stair and preparing to climb to the next level (718). This capability allows the system to simulate a wide range of user-specific movements, as claimed in the disclosure, ensuring that the footwear is broken in under various real-world conditions.

In Addition to walking and climbing stairs, the robot 710 can also navigate uneven terrain, such as gravel or grass, or running on a treadmill. This versatility in movement allows for comprehensive testing of footwear durability and comfort across different surfaces. By simulating diverse environmental conditions, the robot ensures that the footwear meets high standards of performance and user satisfaction.

The robotic motion simulator is configured to replicate a wide range of user-specific movements, including walking, running, and sport-specific actions. This feature is integral to the disclosure, as it allows for the dynamic adaptation of footwear to the user's unique foot structure. By incorporating a variety of movements, the system can address different pressure points and adjust the shoe's fit accordingly, enhancing comfort and performance.

The 3D model creation module is responsible for generating a detailed three-dimensional model of a user's feet. This module utilizes advanced scanning technologies to capture anatomical features such as arch height, toe structure, and skin texture. The accuracy of the 3D model is paramount, as it forms the basis for the subsequent break-in process. By replicating the biomechanical properties of the user's feet, the system ensures that the footwear conforms precisely to the individual's foot shape.

The material emulation module selects materials for the 3D model that mimic the flexibility and thermal characteristics of the user's feet. This module is to ensure that the 3D model accurately represents the user's foot properties, allowing for a more effective break-in process. By emulating the real stiffness and softness of the user's feet, the system can dynamically adjust the shoe's internal structure to alleviate pressure points and enhance comfort.

The control module is configured to customize break-in protocols based on user-specific parameters such as weight distribution, gait analysis, and activity type. This customization can optimize the fit and comfort of the footwear. By adjusting simulation parameters in real-time, the system can provide a personalized break-in experience that caters to the unique needs of each user.

The disclosure offers several advantages, including a personalized fit that reduces the need for trial and error in shoe selection. The system significantly reduces break-in time compared to traditional methods by actively modifying the shoe structure. Additionally, it ensures that footwear is broken in under real-world conditions, enhancing athletic performance and comfort. The system also prevents over-wearing or fabric overstretching, extending the product lifespan by ensuring a perfect fit from the start.

Potential applications of the disclosure include orthopedic rehabilitation, where the system aids in recovery by simulating therapeutic movements and adjusting footwear to accommodate healing feet. Shoe manufacturers can use the system to test and optimize new shoe designs for comfort and performance, providing valuable data for design improvements. The system also offers virtual shoe shopping capabilities, allowing online shoppers to virtually try on shoes for a better fit, with the option to have shoes pre-broken in before delivery. For athletes, the system helps fine-tune their footwear for optimal performance, reducing the risk of injury and enhancing comfort.

Overall, this disclosure provides a comprehensive approach to breaking in shoes, ensuring both comfort and performance. By leveraging 3D modeling and robotic simulation, the system adapts new products to the user's unique physical characteristics, reducing discomfort and enhancing the overall user experience. The focus on dynamic adaptation and real-time feedback represents a significant advancement over existing technologies in the field of footwear customization.

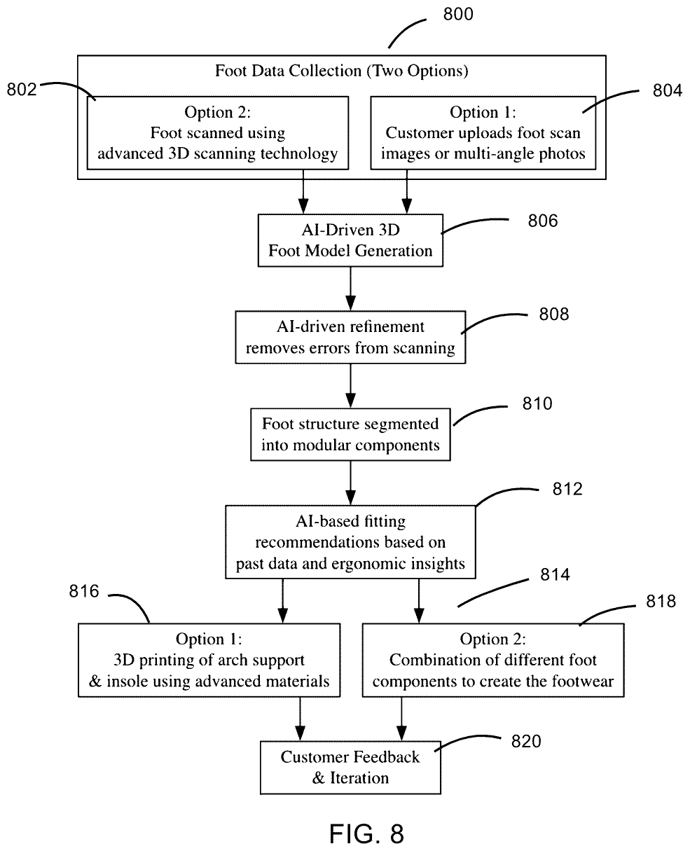

FIG. 8 illustrates the personalized footwear creation process, which encompasses several stages from foot data collection to customer feedback for refinement. The process begins with the Foot Data Collection module 800, which is responsible for gathering detailed information about the user's feet. This can be achieved through two primary methods: Option 1, where customers upload foot scan images or multi-angle photos 802, and Option 2, which involves using advanced 3D scanning technology 804 to capture precise foot dimensions and contours.

The AI-Driven 3D Foot Model Generation module 806 utilizes the collected data to create a highly accurate 3D model of the user's foot. This model generation process is enhanced by AI-driven refinement 808, which removes any errors or inconsistencies from the initial scanning data, ensuring that the model accurately represents the user's foot structure. The foot structure is then segmented into modular components 810, allowing for detailed analysis and customization.

Following the generation of the 3D model, the system provides AI-based fitting recommendations 812. These recommendations are based on past data and ergonomic insights, ensuring that the footwear created will offer optimal comfort and support for the user. The Footwear Creation module 814 then takes over, offering two options for creating the footwear: Option 1 involves 3D printing of arch support and insole using advanced materials 816, while Option 2 combines different foot components to create the footwear 818, allowing for a tailored fit.

For the Customer Feedback & Iteration module 820, feedback from the user is collected to refine and improve the footwear design. This iterative process ensures that the final product meets the user's expectations and provides the desired level of comfort and performance.

The disclosure described in this patent application addresses the common issue of discomfort caused by new shoes, particularly specialized sports footwear. By utilizing a 3D model of the user's feet, the system can simulate real-life movements and adjust the footwear to fit the user's foot shape perfectly. This approach not only reduces the break-in time but also enhances the overall comfort and performance of the footwear.

The 3D Model Creation module is configured to generate a detailed three-dimensional model of a user's feet using scanning technologies. This module captures anatomical features such as arch height, toe structure, and skin texture, providing a comprehensive representation of the user's foot. The Material Emulation module selects materials that replicate the biomechanical properties of the user's feet, including flexibility and thermal characteristics, ensuring that the 3D model behaves like a real foot during the break-in process.

The Robotic Motion Simulator is configured to simulate user-specific movements, such as walking, running, and sport-specific actions. This simulation allows the footwear to adapt to the user's foot structure over time, reducing discomfort and optimizing fit. The Control Module customizes the break-in protocols based on user-specific parameters, such as weight distribution, gait analysis, and activity type, ensuring a personalized fit for each user.

Potential applications of this disclosure include orthopedic rehabilitation, where the system can aid in recovery by simulating therapeutic movements and adjusting footwear to accommodate healing feet. Shoe manufacturers can use the system to test and optimize new shoe designs for comfort and performance, while virtual shoe shopping platforms can offer customers the option to virtually try on shoes for a better fit. Athletes can benefit from the system by fine-tuning their footwear for optimal performance, reducing the risk of injury and enhancing comfort.

The invention described in FIG. 8 represents an advancement in the field of personalized footwear creation. By integrating technologies and user feedback, the system ensures a fit and enhances the overall user experience. This approach addresses the limitations of existing shoe fitting methods and offers a solution for both consumers and manufacturers.

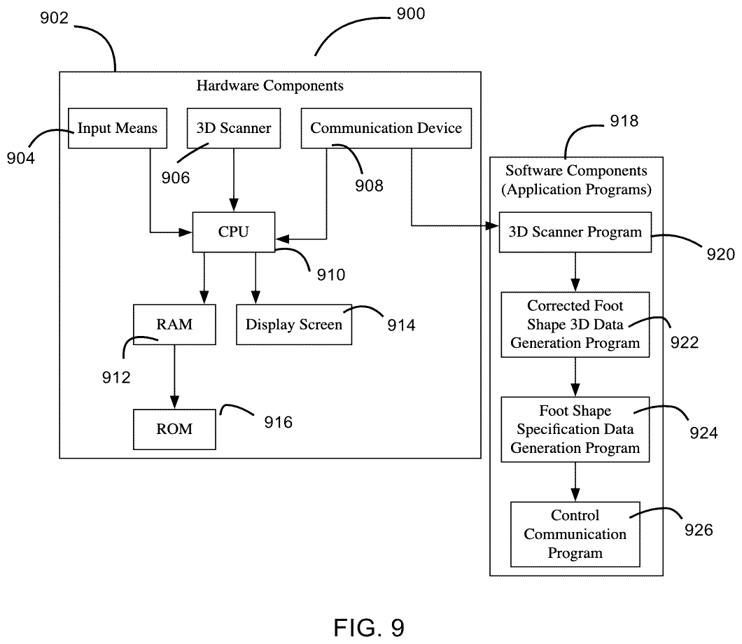

FIG. 9 illustrates a 3D Foot Measurement System, which integrates both hardware and software components to efficiently scan, process, and transmit foot measurement data. The system is designed to enhance the accuracy and efficiency of capturing three-dimensional models of a user's feet, which are crucial for the subsequent customization of footwear.

The diagram for the 3D Foot Measurement System 900 serves as the central framework for the disclosure, detailing the interaction between various components. The hardware components block 902 includes essential elements such as the input means 904, which can be a user interface for initiating scans or inputting data. The 3D scanner 906 is configured to capture detailed three-dimensional images of the user's feet, providing the foundational data for model creation. The communication device 908 facilitates the transmission of data between the scanner and other system components or external devices, ensuring seamless data flow.

The CPU 910 is tasked with processing the scanned data, supported by RAM 912 for temporary data storage and ROM 916 for storing essential system instructions and software. The display screen 914 provides a visual interface for users to interact with the system, view scan results, and make necessary adjustments. Together, these hardware components form a robust platform for capturing and processing foot measurement data.

The software components, represented by application programs 918, are integral to the system's functionality. The 3D scanner program 920 manages the operation of the scanner, ensuring accurate data capture. The corrected foot shape 3D data generation program 922 processes the raw scan data to produce a refined model that accurately represents the user's foot shape. This program is crucial for eliminating any distortions or inaccuracies in the initial scan.

The foot shape specification data generation program 924 further refines the model by generating detailed specifications that can be used for customizing footwear. This program ensures that the final model includes all necessary anatomical features, such as arch height and toe structure, which are critical for achieving a perfect fit. The control/communication program 926 oversees the interaction between hardware and software components, ensuring that data is accurately processed and transmitted throughout the system.

The disclosure's primary purpose is to create a precise 3D model of the user's feet, which can then be used to customize footwear for optimal fit and comfort. By integrating advanced scanning technologies with sophisticated software, the system can capture intricate foot details and simulate real-life movements, allowing for a dynamic and personalized break-in process. This approach significantly reduces discomfort and enhances the overall user experience.

Potential applications of this disclosure include orthopedic rehabilitation, where customized footwear can aid in recovery by providing therapeutic support. Shoe manufacturers can also benefit from this technology by testing and optimizing new shoe designs for comfort and performance. Additionally, the system can enhance virtual shoe shopping experiences by allowing users to virtually try on shoes for a better fit.

The advantages of this disclosure are manifold. It offers a personalized fit by adapting footwear to the individual's unique foot shape, thereby enhancing comfort and performance. The system also reduces break-in time compared to traditional methods, as it actively modifies the shoe's internal structure to conform to the user's foot. This not only improves durability but also optimizes performance by ensuring that footwear is broken in under real-world conditions.

For users without access to a 3D scan device, alternative methods like ML-driven photogrammetry apps can be used to construct a 3D model from multiple 2D photos. Constructing a 3D model from 2D photos involves several steps, often using machine learning and photogrammetry techniques. The process begins with capturing multiple 2D images of the subject from different perspectives using a device like a smartphone camera. More images from various angles lead to a more accurate 3D model, as these images provide comprehensive data about the subject's shape and features.

Once the images are captured, the next step is semantic segmentation, which involves using a machine learning model to distinguish different components of the subject from the background and other elements in the images. This step helps identify and separate the subject's distinct parts, such as body parts or clothing, which are essential for accurate 3D modeling.

After segmentation, parameter extraction is performed to determine various physical attributes of the subject, such as height, head size, or chest girth. These parameters are then applied to a generic parametric 3D model associated with the subject type, such as a human or animal. This involves creating a custom mesh that accurately fits the specific subject based on the extracted parameters.

To enhance the realism of the 3D model, textures are applied using color data from the 2D images. This step involves generating a custom texture that is mapped onto the custom mesh, providing a more lifelike appearance. Optionally, the 3D model can be animated using motion capture data, allowing for the simulation of movement by transferring poses from a motion capture video to the model.

In some cases, photogrammetry techniques are employed to reconstruct the 3D model from multiple 2D images. This involves identifying common points across the images to create a mesh, further enhancing the model's accuracy. Various software tools and systems can be used to implement this process, some of which incorporate advanced machine learning models to improve the efficiency and precision of the 3D model generated.

In summary, the 3D Foot Measurement System provides a comprehensive solution for customizing footwear, leveraging advanced 3D modeling and dynamic simulation to adapt products to the user's unique physical characteristics. This disclosure represents a significant advancement over existing technologies, offering a more precise and efficient method for achieving a perfect fit.

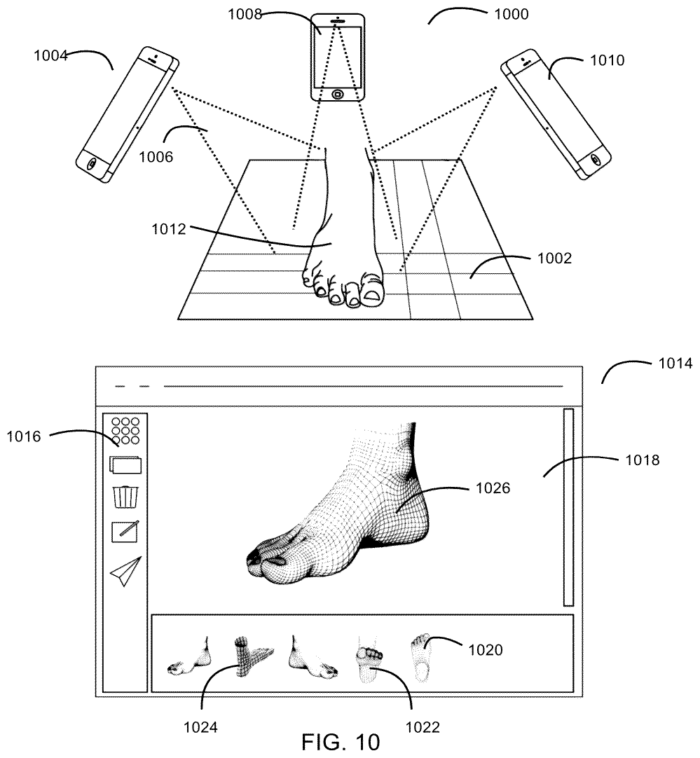

FIG. 10 illustrates a system for capturing 3D images of a foot to create a 3D model, providing an alternative to traditional 3D foot scanners. The system comprises several components, each contributing to the construction of the 3D foot model. The system 1000 is designed to capture images of a foot from multiple angles using a mobile device, thereby facilitating the creation of a detailed 3D model.

The system 1000 utilizes a reference paper with grids 1002, which serves as a measurement aid. The reference paper is placed beneath the foot during the image capture process, providing a consistent scale and orientation reference for the images. This grid system ensures that the dimensions of the foot are accurately represented in the resulting 3D model, as it helps in aligning the images correctly during processing.

The mobile device camera capture positions, labeled as 1004, 1008, and 1010, indicate the various angles from which the foot is photographed. These positions include captures from the left, rear, and right of the foot, respectively. The dotted line 1006 illustrates the path along which the camera is moved to capture images from these different angles. This multi-angle capture can help generate a comprehensive 3D model, as it allows the system to gather data on the foot's contours and dimensions from all sides.

The foot 1012 is positioned on the reference grids during the image capture process. This positioning ensures that the foot remains stable and correctly oriented relative to the reference paper, to ensure accurate image alignment and model construction. The stability provided by the reference grids helps in minimizing distortions or errors in the captured images.

The computer system 1014 is responsible for processing the captured images to construct the 3D foot model. This system utilizes AI-powered algorithms to analyze the images, aligning them based on the reference grids and extracting the necessary data to build the model. The tool panel 1016 on the user interface of the computer system provides various options for manipulating and refining the 3D model, allowing users to adjust parameters, configurations, and settings to ensure the model's accuracy.

The display area 1018 shows the rendered 3D foot model, providing a visual representation of the model as it is being constructed. This display allows users to zoom in, zoom out, and change the angle of the 3D foot model to verify the model's accuracy and make any necessary adjustments in real-time. The different foot scan images in the thumbnail areas provide raw images that were used to construct the 3D models.

For example, image 1020 shown in the thumbnail section, is the foot image taken from the top-down angle. The thumbnail area also provides quick access to the various angles captured during the image capture process, facilitating easy navigation, comparison, and adjustments. Thumbnails 1022 of different captured angles, including a side-view foot scan image 1024, are displayed with different foot images taken from the lower and rear-side capturing angle.

The rendered 3D foot model 1026 represents the output of the system, providing a detailed and accurate 3D representation of the user's foot. This model can be used in various applications, such as virtual shoe fitting, custom footwear design, and orthopedic assessments. Meanwhile, the foot model can be used to create or assemble the physical foot replica of the user. By providing a precise digital and physical replica of the foot, the system enables more accurate and personalized solutions in footwear and related industries.

To assemble the physical replica foot, the computer system contains AI algorithms to select pre-manufactured components and materials that match the user's foot dimensions and characteristics. The pre-manufactured foot components come in various sizes and shapes that can be assembled to create the model foot. The system's AI algorithms analyze the 3D model to determine the best size for each component and the best combination of components, ensuring that the final product closely matches the user's unique foot structure.

These algorithms ensure that the physical replica is as close to the digital model as possible, enhancing the accuracy of custom footwear production. The present disclosure pertains to an advanced system and method for breaking in footwear and sportswear through the utilization of a three-dimensional (3D) model that represents a user's feet or body. The system described herein is designed to enhance the comfort and fit of new footwear by leveraging digital modeling, material emulation, and robotic motion simulation. By incorporating these elements, the disclosure significantly improves the break-in process, reducing discomfort and optimizing performance.

Traditional methods of breaking in new shoes involve prolonged wear, physical adjustments, or manual stretching techniques, which can cause blisters, foot pain, and injury. The system described here addresses these issues by simulating user-specific foot characteristics and movements, ensuring that the footwear conforms to the individual's physical attributes before use. The system includes components such as a 3D model creation module, a material emulation module, a robotic motion simulator, and a control module. Each component has a specific role in pre-conditioning footwear and sportswear for a better fit.

The 3D model creation module generates a detailed representation of the user's feet or body using advanced scanning technologies like 3D scanning and photogrammetry. It captures anatomical features such as arch height, toe structure, foot width, and skin texture, providing an accurate digital representation of the foot for subsequent processes in the break-in procedure.

The digital foot model is created using AI-assisted reconstruction techniques that enhance precision and account for variations in foot posture and movement. The accuracy of the foot model considers details like pressure points, bone structure, and soft tissue distribution, allowing for improvements in fit across multiple footwear designs.

Once the 3D model is generated, the material emulation module selects materials that replicate the biomechanical properties of the user's feet or body. The selected materials exhibit characteristics such as flexibility, stiffness, elasticity, and thermal responsiveness, allowing the digital model to behave similarly to a real human foot. This emulation ensures that pressure distribution, bending behavior, and compression responses reflect real-world usage scenarios.

The material emulation module uses dynamic modeling techniques to replicate the behavior of various foot conditions. This provides insights into how different materials interact with the foot under different conditions, including temperature changes, humidity levels, and varying activity types. The integration of material emulation techniques improves the adaptability of footwear to different climates and user needs.

After creating the 3D model and selecting appropriate materials, the footwear or sportswear is fitted onto the digital model. A robotic motion simulator subjects the footwear to simulated movements that mimic real-world conditions. The simulator replicates user-specific actions such as walking, running, jumping, and sport-specific maneuvers, allowing footwear to be pre-conditioned under dynamic conditions.

The robotic motion simulator includes actuators, pressure sensors, and adaptive controllers that adjust movements based on biomechanical data. By mimicking various walking speeds, angles, and pressure applications, the simulator optimizes the shoe's break-in process more efficiently than conventional methods. Replicating the wear-and-tear of daily use allows users to experience enhanced comfort from the first time they wear the footwear.

The control module customizes break-in protocols based on user-specific parameters. It analyzes gait dynamics, weight distribution, and movement tendencies to adjust simulation parameters. Real-time feedback mechanisms allow for dynamic adjustments throughout the break-in process. Sensors within the 3D model monitor pressure distribution and detect potential discomfort points, enabling modifications to the shoe's internal structure to enhance comfort and performance.

AI-driven adaptive control algorithms allow the system to learn from previous break-in experiences to refine the fit of future footwear iterations. Predictive analysis from the control module allows for improvements in shoe design, reducing material waste and ensuring performance for various user types.

This disclosure introduces a system and method for breaking in footwear and sportswear using a 3D model-assisted approach. Designed to address the discomfort associated with new shoes, particularly specialized sports footwear such as ski boots, hiking shoes, and tennis shoes, the system dynamically adapts shoes to the user's foot structure, ensuring a personalized fit and reducing break-in time. The system comprises multiple components that work together to replicate real-life conditions and adjust footwear to match an individual's unique foot shape and biomechanics.

The 3D model creation module generates a precise three-dimensional representation of the user's feet or body using advanced scanning technologies. This module captures essential anatomical features such as foot shape, size, arch height, toe structure, and internal bone alignment to ensure an accurate model. The model is constructed using materials that replicate the biomechanical properties of the user's feet, including their stiffness, softness, and texture. By mimicking the natural characteristics of the user's feet, the system ensures that shoes and sportswear conform precisely to the individual's physical attributes, reducing discomfort and optimizing performance.

The material emulation module selects materials that mimic the natural flexibility, thermal characteristics, and pressure distribution of real feet. This ensures that the 3D model behaves like a real foot when subjected to movement and pressure, enhancing the accuracy of the break-in process. The material properties are designed to simulate the dynamic response of human feet under different conditions, including walking, running, and high-impact activities. The material emulation module allows for adjustments to the stiffness and elasticity of the model to better replicate the user's natural foot motion and weight distribution.

A robotic motion simulator is configured to simulate user-specific movements such as walking, running, and various sport-specific actions. The simulator is programmed to replicate the complex biomechanics of human foot motion, subjecting the footwear to realistic stress and movement patterns. By continuously moving the shoe in a controlled environment, the system ensures that the footwear gradually adapts to the user's specific foot structure. This controlled adaptation reduces the need for manual break-in periods and eliminates discomfort caused by stiffness or improper fit. The system is designed to apply varying levels of force and motion intensity based on the type of footwear being tested and the user's activity profile.

The control module customizes break-in protocols based on user-specific parameters such as weight distribution, gait analysis, and activity type. The control module processes input from the 3D model and robotic simulator to dynamically adjust the break-in process, optimizing comfort and fit while minimizing pressure points. The system incorporates machine learning algorithms to refine break-in settings over multiple sessions, ensuring a progressively better fit for the user. By continuously adjusting simulation parameters, the control module personalizes the break-in process to match individual biomechanics, accounting for variations in movement patterns, pronation, and arch support requirements.

A dynamic pressure adjustment feature integrates sensors within the 3D model to monitor pressure distribution during simulated activities. Real-time adjustments are made to the shoe's internal structure to alleviate pressure points, enhance comfort, and ensure that the footwear conforms accurately to the user's foot shape. The sensors track variations in pressure and detect high-friction areas where discomfort is likely to occur. By using this data, the system applies targeted adjustments to modify the shoe's structure, redistributing pressure evenly across the foot. The ability to detect and adjust pressure in real time reduces the risk of blisters, hot spots, and other discomforts commonly associated with new shoes.

The material adaptation feature allows sections of the 3D model to have variable stiffness, simulating different foot conditions. This feature enables shoes to conform more accurately using heat or mechanical adjustments. The system can adjust specific areas of the shoe based on the user's needs, such as softening materials around the toes while maintaining rigidity in the arch support. This selective adaptation ensures that footwear remains structurally sound while providing customized comfort for the wearer. The system is capable of integrating temperature-controlled components to further refine the adaptation process by softening materials at precise locations to enhance flexibility without compromising support.

The system provides several advantages over traditional break-in methods. By creating a personalized fit that conforms to the user's unique foot shape, the need for trial and error in shoe selection is significantly reduced. The automated adaptation process minimizes discomfort by shortening the break-in period and ensuring that footwear is comfortable from the outset. The system enhances efficiency by reducing the amount of time required for shoes to become wearable under real-world conditions. Additionally, by preventing over-wearing or fabric overstretching, the system extends the durability of footwear and sportswear, preserving their intended fit and structure for a longer period.

In orthopedic rehabilitation, the system aids recovery by simulating therapeutic movements and adjusting footwear to accommodate healing feet. This application benefits patients who require specialized footwear support to manage foot injuries or post-surgical conditions. By customizing the break-in process to match medical needs, the system enhances rehabilitation outcomes by ensuring that shoes provide optimal support and pressure distribution. The system can also be applied in physical therapy programs where precise adjustments to footwear are necessary to facilitate mobility recovery.

Shoe manufacturers can use the system to test and optimize new shoe designs for comfort and performance. The ability to simulate real-world wear conditions allows manufacturers to refine materials, improve structural support, and validate ergonomic features before mass production. The system provides valuable data on wear patterns, pressure distribution, and material performance, enabling the development of footwear that better meets consumer needs. By incorporating dynamic testing into the design process, manufacturers can reduce product defects and improve customer satisfaction with better-fitting shoes.

In virtual shoe shopping, the system allows online shoppers to virtually try on shoes for a better fit, with the option to have shoes pre-broken in before delivery. This innovation enhances the e-commerce experience by providing users with an accurate representation of how a shoe will fit before purchase. By simulating the break-in process, customers receive footwear that is more comfortable from the first wear, reducing the likelihood of returns due to improper fit. The system can integrate with online retail platforms to offer personalized shoe recommendations based on a user's foot model and movement data.

For athletes, the system helps fine-tune footwear for optimal performance, reducing the risk of injury and enhancing comfort. By customizing break-in protocols to match the biomechanical demands of specific sports, athletes can ensure that their shoes provide the necessary support and flexibility for peak performance. The system allows for sport-specific adjustments, such as reinforcing stability for lateral movements in tennis or increasing shock absorption for long-distance running. By reducing break-in time, athletes can immediately benefit from shoes that enhance their agility, endurance, and overall performance.

This disclosure provides a comprehensive approach to breaking in shoes and sportswear, leveraging 3D modeling and robotic simulation to adapt new products to the user's unique physical characteristics. By focusing on dynamic adaptation and real-time feedback, the system ensures a comfortable, personalized fit, significantly reducing break-in discomfort while enhancing performance and durability. The integration of advanced scanning technologies, motion simulation, and pressure-sensitive adjustments represents a significant advancement over traditional break-in methods, providing a more efficient, user-friendly solution for footwear customization.

In another aspect, a walking assistance device with flexible force coupler is provided, which may or may not be functioned together with the shoe breaking in apparatus described above.

The assistive devices encompass technologies designed to augment human capabilities and address limitations in mobility, strength, or endurance, and more specifically to a highly refined and innovative device meticulously engineered to facilitate walking or travel between two individuals exhibiting disparate levels of physical capacity by means of a dynamically responsive and ergonomically optimized system for flexibly transferring push or pull forces. The domain of assistive devices is a rapidly expanding and critically important area of technological development, driven by the increasing global aging population, the rising prevalence of mobility-impairing conditions, and a growing societal emphasis on maintaining active and independent lifestyles across all age groups and physical abilities. This invention represents a significant advancement within this field by directly addressing a specific and often overlooked need: the provision of comfortable, effective, and intuitive dyadic mobility assistance, particularly in scenarios involving walking, hiking, and other forms of pedestrian travel. The core novelty and inventive step of this device lie in its unique flexible force coupler mechanism, which is specifically designed to seamlessly integrate with the complex and often unpredictable biomechanics of human locomotion, thereby creating a more natural, less restrictive, and significantly more user-friendly assistive experience compared to existing rigid or semi-rigid coupling solutions or cumbersome manual assistance methods. This invention aims to bridge a critical gap in current assistive technologies by providing a practical and elegant solution for enhancing shared mobility experiences.

During a wide spectrum of activities, ranging from leisurely urban strolls and recreational walking in parks to more demanding pursuits such as hiking across varied and uneven terrains, navigating crowded environments, or engaging in other forms of travel where two or more individuals move in close proximity, inherent disparities in physical ability, inherent stamina, overall endurance, or even temporary limitations due to fatigue or minor injury between individuals can rapidly create substantial challenges and potentially and significantly diminish the overall enjoyment, safety, and sustainability of the shared activity and experience for all participants. For example, a young child, whose musculoskeletal system is still developing and who possesses inherently lower levels of stamina compared to adults, an elderly person experiencing age-related declines in muscle strength, joint flexibility, and cardiovascular capacity, or an individual in the process of recovering from a musculoskeletal injury or managing a chronic condition that impacts mobility may become noticeably fatigued, experience discomfort, or struggle to maintain pace considerably more quickly than a physically robust adult, a more conditioned companion, or a generally more physically capable individual, thereby directly hindering the smooth progress, overall pace, and ultimately the collective enjoyment and satisfaction of the activity for both parties intimately involved in the shared experience. Conventional, often ad-hoc, and frequently improvised solutions to this ubiquitous problem of mobility disparity frequently and inefficiently involve physically carrying the weaker individual, such as a parent carrying a tired child piggyback or in their arms, or relying on less effective and often unstable methods such as hand-holding, arm-linking, or pushing a stroller or wheelchair. While these rudimentary methods may offer some immediate, albeit limited, assistance in specific situations, they are demonstrably and exceptionally physically demanding for the stronger individual, particularly when sustained over extended periods of time, across longer distances, or when traversing challenging terrains characterized by inclines, uneven surfaces, or obstacles, inevitably leading to significant physical strain, premature fatigue, muscular discomfort, and even the potential for musculoskeletal injury for the assisting person. Furthermore, these traditional methods often inherently lack the necessary stability, control, and ergonomic support required for safe and sustained assistance, potentially and significantly increasing the risk of accidental falls, stumbles, or loss of balance for both individuals involved, especially when navigating uneven surfaces, encountering unexpected obstacles, or during sudden or unpredictable movements. The conspicuous absence of a dedicated, ergonomically optimized, and specifically engineered solution for dyadic walking assistance in the current landscape of assistive technologies unequivocally highlights a significant and unmet need and a clear gap in available support systems for shared mobility.

Existing devices and technologies do exist in the commercial marketplace, primarily and almost exclusively within the niche domain of cycling accessories and equipment, that are designed to mechanically couple bicycles together, effectively allowing a stronger cyclist to efficiently and directly assist a weaker cyclist, typically for purposes such as tandem riding, towing a child's bicycle, or providing support during uphill climbs or longer cycling journeys. However, it is critically important to recognize that these existing bicycle coupling devices, while functionally effective within their intended domain, are almost invariably and fundamentally designed to be rigidly constructed or at best possess only semi-rigid characteristics, meticulously engineered and optimized specifically for the highly predictable geometry, relatively constrained dynamics, and inherently smooth motion characteristics that are fundamentally and uniquely inherent in the operation of bicycles on paved or relatively smooth surfaces. These bicycle-specific coupling devices are demonstrably and fundamentally not readily adaptable, nor are they ever intended or designed for practical or safe use in the context of the highly variable, significantly less predictable, and often inherently asynchronous and biomechanically complex movements that are routinely encountered during natural human walking or hiking activities across diverse terrains. The inherent and intentional rigidity of existing bicycle couplers, while demonstrably suitable and even essential for maintaining stable and predictable spatial relationships and controlled force transfer between two bicycles operating on smooth surfaces, can directly and inevitably translate into significant user discomfort, pronounced instability, and even a heightened potential for physical injury when hypothetically and inappropriately repurposed or attempted to be utilized in pedestrian settings or for walking assistance applications. To vividly illustrate this critical point, one can readily imagine the impracticality and potential hazards of attempting to utilize a rigid bicycle coupler to mechanically connect two individuals attempting to walk together—every subtle change in walking pace, every minor adjustment in walking direction, every natural variation in individual stride length, and every slight shift in body weight or posture would be harshly and directly transmitted through the rigid coupler, instantaneously creating jarring and unpredictable jerking motions, inducing significant imbalance, and resulting in a generally unpleasant, biomechanically inefficient, and potentially unsafe and injury-provoking experience for both users. Furthermore, bicycle couplers are typically and necessarily constructed from relatively heavier and more robust materials, such as steel or heavy-gauge aluminum, specifically chosen and engineered to withstand the substantial stresses and dynamic loads encountered during cycling activities, making them unnecessarily bulky, excessively heavy, and inherently cumbersome for pedestrian-focused applications, where the paramount design priorities are lightweight construction, unobtrusive form factor, and minimal encumbrance on the user's natural movements. The fundamental and irreconcilable differences in biomechanics, intended operational environments, and user requirements unequivocally render bicycle coupling technology fundamentally unsuitable and wholly inappropriate for effectively addressing the specific and nuanced needs of comfortable and safe walking assistance between individuals with differing physical capabilities.

Therefore, based on a comprehensive understanding of the inherent limitations of current assistive solutions, a thorough recognition of the unique biomechanical challenges and ergonomic considerations associated with dyadic walking assistance, and a clear articulation of the unmet needs within this specific domain, there exists a demonstrably defined and critically important unmet need for a specifically and purposefully designed walking assistance device that is capable of effectively, comfortably, and safely transferring assistive force between individuals exhibiting differing physical capabilities while simultaneously and crucially accommodating the naturally occurring variations, inherent asymmetries, and biomechanically independent movements that are intrinsically characteristic of their respective gaits and individual ambulation patterns. Such a device, to be genuinely practical for real-world use, readily adoptable by a broad user base, and commercially viable, must demonstrably and critically exhibit several key performance characteristics and design attributes. It must be inherently lightweight in its construction to minimize any added burden or encumbrance on the users during walking, it must be easily and intuitively adjustable in its dimensions and configuration to seamlessly cater to a broad and diverse range of user body sizes, physical proportions, and intended activity types, and most importantly and crucially, it must incorporate and provide a carefully and precisely engineered degree of biomechanical flexibility within its core force transfer mechanism to significantly and demonstrably enhance user comfort, effectively minimize stress and strain on joints and musculoskeletal structures, and proactively and reliably prevent any potential for injury to both the assisting and the assisted individuals during sustained use across a wide spectrum of walking and hiking scenarios, including varied terrains and unpredictable environments. The ultimate objective of this invention is to effectively and seamlessly bridge the critical gap between providing demonstrably effective and reliable walking assistance and simultaneously preserving the natural, comfortable, biomechanically sound, and inherently safe experience of walking alongside another person in a coordinated and harmonious manner, thereby fostering greater inclusivity and shared enjoyment of physical activities.

The present disclosure directly, comprehensively, and effectively addresses the clearly articulated and previously identified needs and decisively overcomes the inherent limitations of prior art solutions by providing a groundbreaking and innovative walking assistance device specifically and purposefully comprising a thoughtfully and ergonomically designed first holder meticulously configured for secure, comfortable, and nonrestrictive attachment to a first individual (typically and preferentially the stronger or assisting person), a similarly and symmetrically designed second holder engineered for secure, comfortable, and equally non-restrictive attachment to a second individual (typically and preferentially the weaker or assisted person), and a uniquely and ingeniously engineered coupler component strategically positioned and functionally operating between the first holder and the second holder to establish a dynamically responsive and biomechanically compliant connection. The central and transformative innovation of this device unequivocally resides in the coupler's deliberate and highly refined configuration, which is meticulously and precisely designed to flexibly, efficiently, and comfortably transfer a push or pull force intentionally generated by the first individual to the second individual, thereby providing direct, targeted, and biomechanically sound walking assistance while simultaneously and critically preserving a natural, unrestricted, and comfortable range of motion and freedom of movement for both users throughout the entire walking experience. This carefully engineered and dynamically responsive flexible force transfer mechanism is unequivocally the key differentiating feature of this invention, fundamentally distinguishing it from rigid or semi-rigid connectors and establishing its essential suitability and practical applicability for real-world walking, hiking, and pedestrian mobility scenarios.

The coupler, in its most preferred and optimized embodiment, is structurally and functionally characterized by comprising a centrally located and substantially rigid middle portion, which serves as the primary and essential load-bearing structural element responsible for efficient, direct, and reliable force transmission along the intended axis of assistance, and strategically and symmetrically positioned flexible portions meticulously located at each distal end of the rigid middle portion, specifically engineered to interface directly and seamlessly with the first and second holders respectively, thereby establishing the dynamic and biomechanically compliant connection points. These strategically placed and precisely engineered flexible portions are absolutely crucial and fundamentally essential for allowing a necessary, beneficial, and carefully controlled degree of relative freedom of movement, biomechanical compliance, and independent motion between the first individual and the second individual, effectively, comfortably, and safely accommodating the inevitable and naturally occurring differences in individual stride length, variations in preferred walking pace, subtle and frequent adjustments in directional changes, and minor but biomechanically significant shifts in body position and posture that routinely and naturally occur during the complex and dynamic process of human walking. The deliberate and strategic presence of the rigid middle portion is equally essential and functionally critical to ensure efficient, direct, and predictable force transfer along the primary axis of mechanical connection, thereby maximizing the intended assistive effect and ensuring reliable force transmission, while simultaneously and concurrently maintaining a stable, predictable, and controlled mechanical connection between the two individuals, effectively preventing excessive slack, uncontrolled oscillations, or unpredictable movements that could potentially compromise user safety, diminish user comfort, or reduce the overall effectiveness of the walking assistance device. This meticulously and thoughtfully balanced design, incorporating both rigid and flexible structural elements within the coupler component, is demonstrably central to the invention's overall functionality, user-friendliness, biomechanical compatibility, and practical utility in real-world walking assistance applications.

In one exemplary, illustrative, and highly practical embodiment of the disclosure, the first and second holders are realized as ergonomically advanced and thoughtfully designed harnesses specifically and intentionally intended to be comfortably, securely, and non-restrictively worn by the respective individuals, typically and preferentially positioned around their torso or upper shoulders, thereby offering a biomechanically stable, weight-distributing, and ergonomically sound attachment point for the coupler component. These harnesses are preferentially and optimally designed to be readily and intuitively adjustable across a comprehensive range of anthropometric dimensions, enabling them to comfortably, securely, and reliably accommodate a remarkably diverse spectrum of user body sizes, varying body shapes, and different thicknesses of clothing layers worn by users in diverse environmental conditions, thereby ensuring a highly personalized, optimally secure, and consistently comfortable fit for a wide and representative spectrum of potential users across different age groups and physical characteristics. The flexible portions of the coupler, which are absolutely critical for the device's inherent adaptive nature, biomechanical compliance, and user comfort, may be implemented using a diverse array of resilient materials, advanced mechanical elements, and sophisticated damping technologies, including, but not limited to, exceptionally high-tensile elastic cords meticulously crafted from advanced and durable polymers exhibiting superior elasticity, fatigue resistance, and environmental stability, precisely engineered mechanical springs with carefully calibrated spring constants specifically selected to provide a finely tuned and controlled level of biomechanical flexibility and responsiveness, or other cutting-edge resilient materials and damping solutions such as advanced elastomeric polymers, viscous-elastic gels, or even miniature hydraulic or pneumatic dampers that offer a sophisticated combination of controlled flexibility, efficient energy absorption, and exceptional long-term durability, allowing for remarkably smooth, dynamically responsive, and biomechanically optimized force transfer across a wide range of walking conditions and user movements. The rigid middle portion, which is fundamentally responsible for the coupler's overall structural integrity, load-bearing capacity, and efficient force transmission characteristics, may be advantageously and optimally constructed as a telescoping rod assembly, meticulously fabricated from exceptionally lightweight yet remarkably strong and durable materials such as high-grade aluminum alloy, advanced carbon fiber composite materials, or titanium alloys, thereby allowing for convenient, intuitive, and user-controlled adjustment of the effective longitudinal distance between the two individuals mechanically connected by the walking assistance device, enabling seamless adaptation to varying terrains, diverse user preferences regarding proximity, and a wide range of intended activity types, from close-proximity walking in crowded areas to more spaced-out hiking on trails.

The present disclosure, through its refined innovative design, thoughtfully selected functional components, and biomechanically optimized force transfer mechanism, provides a demonstrably highly practical, remarkably user-centric, and unequivocally comfortable solution specifically and purposefully engineered for effectively and safely assisting individuals during walking, hiking, recreational strolling, or other forms of shared pedestrian travel. It uniquely and effectively empowers a stronger individual to impart targeted, controlled, and biomechanically sound physical support and positive encouragement to a weaker individual, thereby significantly and demonstrably enhancing the overall quality of the shared experience, actively promoting social inclusivity, and fostering greater and more equitable participation in physical activities for individuals exhibiting diverse and often disparate physical capabilities. The device not only demonstrably mitigates physical strain and fatigue on both individuals involved in the dyadic walking activity but also actively cultivates a more harmonious, enjoyable, and mutually supportive shared activity, enabling significantly longer durations of travel, facilitating exploration of more challenging and diverse environmental settings, and fostering a stronger sense of companionship, mutual encouragement, and shared accomplishment during outdoor pursuits and everyday mobility scenarios. Ultimately, the overarching aim and intended outcome of this groundbreaking invention is to make shared walking, hiking, and pedestrian mobility experiences more universally accessible, inherently enjoyable, demonstrably safer, and ecologically sustainable for a significantly wider range of individuals, dyadic pairings, and diverse user populations, thereby promoting healthier, more active, and more socially inclusive lifestyles.

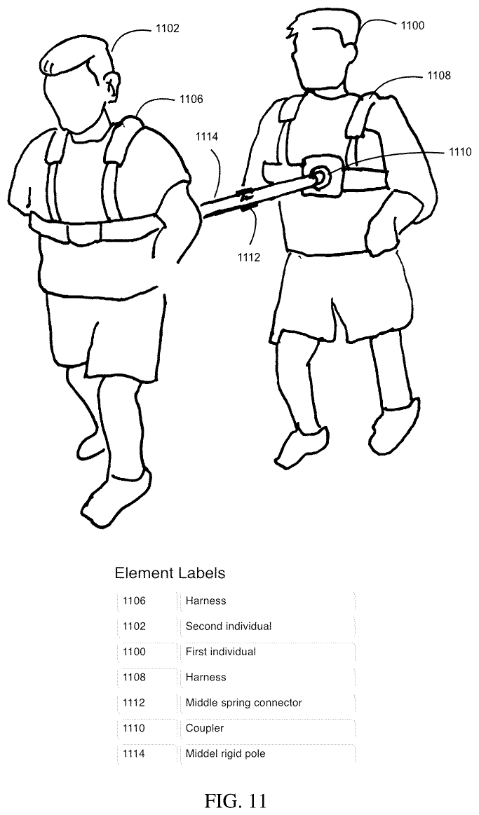

FIG. 11 is a comprehensive perspective view of the walking assistance device in a representative in-use configuration, clearly and visually illustrating a first individual (typically and preferentially the assisting person) effectively and efficiently assisting a second individual (typically and preferentially the assisted person) during a typical ambulation scenario, thereby visually highlighting the practical functional application of the device in a realistic and representative real-world usage context.

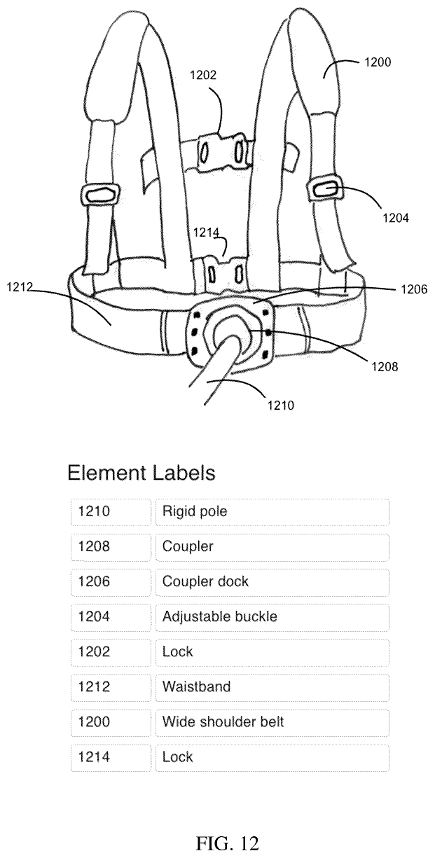

FIG. 12 is a comprehensive perspective view of the first holder (specifically in a harness embodiment), meticulously showcasing its ergonomic design features, adjustable straps and buckles, strategically positioned attachment points for the coupler, and integrated padding elements, thereby emphasizing the key design features that contribute to optimal user comfort, secure fit, and ease of use for the assisting individual.

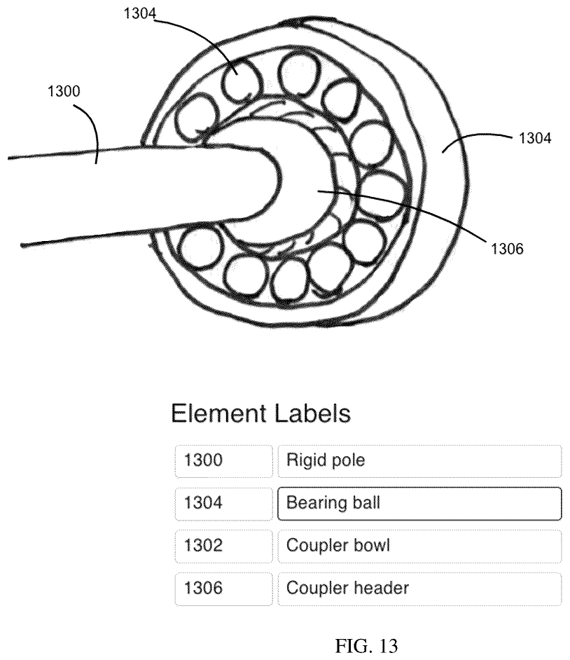

FIG. 13 is a detailed and enlarged view of the coupler component, which is the core functional element of the invention, specifically and meticulously focusing on and clearly delineating the substantially rigid middle portion, which is primarily responsible for efficient and direct force transfer, and the strategically positioned flexible end portions, which are ingeniously designed to accommodate relative movement, enhance user comfort, and ensure biomechanical compatibility during walking.

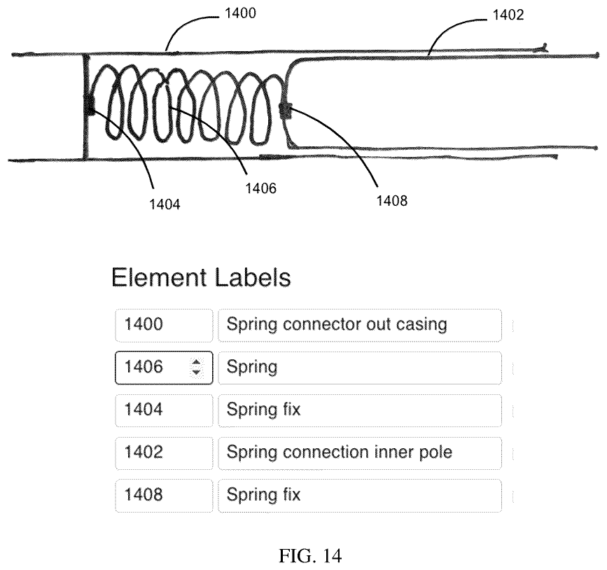

FIG. 14 is a revealing cross-sectional view of the middle part of the rigid pole which has a spring to connect two poles to provide a range of movement forward and backward, meanwhile the force from both individuals can be transferred and buffered.

More specifically, FIG. 11 is a comprehensive perspective view of the walking assistance device in a representative in-use configuration, clearly and visually illustrating a first individual (1100) (typically and preferentially the assisting person) effectively and efficiently assisting a second individual (1102) (typically and preferentially the assisted person) during a typical ambulation scenario, thereby visually highlighting the practical functional application of the device in a realistic and representative real-world usage context.

As depicted in FIG. 11, the walking assistance device is shown in its operational environment, facilitating the ambulation of the second individual (1102) by the first individual (1100). The first individual (1100), acting as the assisting person, is positioned behind the second individual (1102), the assisted person. The core components of the device are clearly visualized in this in-use configuration. A middle rigid pole (1104) is shown extending between the first individual (1100) and the second individual (1102). The first individual (1100) is secured to the device via a first harness (1106) worn around their torso. Similarly, the second individual (1102) is connected to the device through a second harness (1108), also worn around their torso. The connection between the harnesses (1106, 1108) and the middle rigid pole (1104) is achieved via couplers (1110) at each end of the pole. A middle spring connector (1112) is integrated into the middle rigid pole (1104), visibly positioned centrally along the pole's length. This figure effectively demonstrates the overall system and its intended use, showcasing how the device enables controlled and supported movement of the second individual (1102) under the guidance and assistance of the first individual (1100).

FIG. 12 is a comprehensive perspective view of the first holder (specifically in a harness embodiment), meticulously showcasing its ergonomic design features, adjustable straps and buckles, strategically positioned attachment points for the coupler, and integrated padding elements, thereby emphasizing the key design features that contribute to optimal user comfort, secure fit, and ease of use for the assisting individual.

FIG. 12 provides a detailed perspective view of the first harness, which serves as the first holder for the assisting individual. The harness is designed for ergonomic comfort and secure fit. A wide shoulder belt (1200) is prominent, designed to distribute weight comfortably across the assisting individual's shoulders. A waistband (1212) is also clearly visible, encircling the waist and contributing to the secure and stable positioning of the harness on the wearer's body. The waistband (1212) is secured and adjusted using a waist lock (1202), allowing for customized fitting around the waist. Adjustable buckles (1204) are strategically located on the straps of the harness, enabling further customization of the fit and ensuring a snug yet comfortable arrangement for various body sizes. A coupler dock (1206) is a key feature, representing the designated attachment point on the harness for the coupler (1208). The coupler dock (1206) is positioned to facilitate a secure and functional connection with the coupler (1208), which is also depicted in this view connected to a section of the rigid pole (1210). This detailed view highlights the user-centric design of the first harness, emphasizing features that prioritize comfort, adjustability, and a secure interface for connection to the walking assistance device.

FIG. 13 is a more detailed and enlarged view of the coupler component, which is the core functional element of the invention, specifically and meticulously focusing on and clearly delineating the substantially rigid middle portion (1300), which is primarily responsible for efficient and direct force transfer, and the strategically positioned flexible end portions, which are ingeniously designed to accommodate relative movement, enhance user comfort, and ensure biomechanical compatibility during walking.

FIG. 13 offers an enlarged and detailed view of the coupler, a critical component for force transmission and flexible connection within the walking assistance device. The coupler comprises a substantially rigid middle portion, identified as the rigid pole (1300) section, which is engineered for efficient and direct transfer of forces between the assisting and assisted individuals. At one end of this rigid pole (1300) section, a coupler bowl (1302) is depicted. The coupler bowl (1302) is designed to interface with a bearing ball (1304). The bearing ball (1304) is shown positioned within the coupler bowl (1302), enabling a degree of rotational and pivotal movement. On the opposite side of the bearing ball (1304), a coupler header (1306) is illustrated. The coupler header (1306) is designed to connect to the harness or holder component, providing a flexible attachment point. This detailed view of the coupler emphasizes its dual functionality: providing rigid force transmission through the middle portion (1300) while simultaneously allowing for necessary flexibility and movement through the ball and bowl joint (1302, 1304) and the coupler header (1306), thereby enhancing user comfort and accommodating natural ambulation dynamics.

FIG. 14 is a revealing cross-sectional view of the middle part of the rigid pole which has a spring to connect two poles to provide a range of movement forward and backward, meanwhile the force from both individuals can be transferred and buffered.

FIG. 14 presents a cross-sectional view of the middle spring connector, illustrating its internal mechanism for providing controlled flexibility and force buffering within the rigid pole. The spring connector out casing (1400) represents the external housing of the spring connector, providing structural integrity and protection to the internal components. Within this casing, a spring connection inner pole (1402) is visible, indicating a section of pole that is internal to the spring mechanism and interacts directly with the spring. Spring fix (1404) and another spring fix (1408) are shown at opposing ends of the spring, indicating components that secure and position the spring within the casing and relative to the inner pole (1402). A spring (1406) is centrally located within the cross-section, clearly illustrating the elastic element responsible for providing the range of movement and force buffering. This cross-sectional view effectively demonstrates how the spring (1406), in conjunction with the other components (1400, 1402, 1404, 1408), is integrated into the rigid pole to allow for controlled forward and backward movement while simultaneously buffering and transferring forces between the assisting and assisted individuals, contributing to a smoother and more comfortable walking assistance experience.

The first holder, an interface between the device and the first individual (1100), is meticulously designed to be comfortably and securely worn by the assisting individual. It is conceived to be versatile in form, capable of taking various configurations including, but not limited to, a harness that distributes weight across the torso and shoulders, a belt worn around the waist, or a vest that integrates seamlessly with clothing. The paramount requirement for the first holder is its ability to provide a reliably secure and ergonomically comfortable attachment point for the coupler (1110), ensuring efficient force transfer and preventing slippage or discomfort during use. The first holder must be readily adjustable in size and fit to comfortably accommodate a diverse range of body sizes, body shapes, and variations in clothing thicknesses worn by different users. Suitable materials for constructing the first holder are carefully chosen to balance durability, lightweight characteristics, and user comfort, and may encompass materials such as high-strength nylon webbing, durable polyester fabrics, robust canvas materials, or other advanced technical textiles that are lightweight, breathable, and resistant to wear and tear. To further enhance user comfort, particularly during prolonged use, the first holder may incorporate strategically placed padding made of breathable foam, moisture-wicking fabrics, or gel-based cushioning, especially at pressure points such as shoulders, back, or waist, to optimize weight distribution and minimize chafing or discomfort.

Functionally analogous to the first holder, the second holder is specifically designed to be comfortably and securely worn by the second individual (1102), typically the person being assisted. Mirroring the versatility of the first holder, the second holder can also adopt various forms, such as a harness, a belt, or a vest, and should similarly be adjustable to achieve a personalized and secure fit for a wide range of body sizes and shapes, ensuring comfort and stability for the assisted individual. Given the intended user profile of the second individual, who may often be a child, an elderly person, or someone with reduced mobility, the second holder design may incorporate additional safety features beyond basic comfort and adjustability. These enhanced safety features could include the integration of reflective strips or panels made from high-visibility reflective materials to improve visibility in low-light conditions, enhancing safety during outdoor use, and a strategically positioned quick-release mechanism, such as a readily accessible buckle or clip, allowing for rapid and immediate disconnection from the device in case of an emergency or unforeseen situation, prioritizing the safety and well-being of the assisted individual.

Coupler (1110): The coupler stands as the central and most innovative component of the invention, acting as the critical link responsible for effectively and comfortably transferring push or pull forces between the first and second individuals. It is structurally and functionally defined by comprising two key sub-components: a rigid middle portion (1114) that ensures efficient force transmission, and flexible portions (1112, 1110) strategically located at each end of the rigid middle portion to accommodate relative movement and enhance user comfort. The coupler's design and material selection are paramount to achieving the desired balance of force transfer efficiency, flexibility, durability, and lightweight characteristics.

Rigid Middle Portion (1114): This structurally critical portion of the coupler is designed to provide the primary structural integrity and stiffness necessary for efficient and direct force transfer along the longitudinal axis of the device. The rigid middle portion is intended to minimize energy loss due to deformation and ensure that the force applied by the first individual is effectively transmitted to the second individual. Materials suitable for the rigid middle portion are chosen for their high strength-to-weight ratio and rigidity, and may include, but are not limited to, lightweight and strong aluminum alloys, high-performance carbon fiber composites known for their exceptional stiffness and low weight, high-strength steel alloys for robustness and durability, or advanced rigid polymers specifically engineered for structural applications requiring high stiffness and impact resistance. The length of the rigid middle portion can be designed to be fixed for simplicity and optimized performance in specific use cases, or alternatively, it can be made adjustable, for example, by employing a telescoping mechanism, allowing users to customize the distance between the connected individuals based on terrain, personal preference, or activity type.

Flexible Portions (1110, 1112): These strategically positioned portions of the coupler are essential for introducing controlled flexibility into the force transfer mechanism, thereby enabling relative movement and independent motion between the first and second individuals, accommodating natural variations in gait, walking pace, directional changes, and minor shifts in body position. The flexible portions are designed to prevent jerky movements and discomfort, ensuring a smoother and more natural walking experience for both users. Various mechanisms and material implementations can be employed to achieve the desired flexibility in these portions, including:
Flexible coupler which can provide almost 360 degrees movement.

Springs: Utilizing precisely engineered mechanical springs, such as coil springs, leaf springs, or elastomer-based springs, in the flexible portions offers a more controlled and predictable form of flexibility. The spring constant of the chosen springs can be meticulously selected and tuned to provide the desired level of resistance, compliance, and damping characteristics, allowing for fine-tuning of the device's response to user movements and force inputs.

Elastomeric Materials: Employing elastomeric materials, such as natural rubber, synthetic rubber compounds, or polyurethane elastomers, to create flexible joints, bushings, or connecting elements within the flexible portions offers a robust and durable approach to achieving flexibility. These materials inherently provide a combination of flexibility, elasticity, and inherent damping properties, effectively absorbing shocks and vibrations while allowing for controlled relative motion.

Flexible Joints: Incorporating mechanical flexible joints, such as hinges, ball-and-socket joints, or universal joints, into the flexible portions provides a more articulated and defined range of motion. These joints allow for a wider range of angular movement and rotational freedom between the rigid middle portion and the holders, enabling greater adaptability to complex and varied movements during walking and hiking.

Support Portions (1206, 1212): These structurally robust portions of the coupler serve as the crucial interface connecting the flexible portions (1302, 1306) to the rigid middle portion (1300). Their primary function is to ensure that the force transmitted through the flexible portions is effectively and efficiently transferred to the rigid middle portion without energy loss or structural failure. To fulfill this function, the support portions are designed to be substantially rigid themselves, fabricated from materials with high stiffness and strength, similar to those used for the rigid middle portion, such as aluminum alloy, carbon fiber composite, or rigid polymers. The rigid nature of the support portions maintains the structural integrity of the coupler assembly and ensures direct and efficient force transmission along the intended load path.

Adjustable Length Coupler: To enhance the versatility and adaptability of the walking assistance device, the length of the rigid middle portion of the coupler can be engineered to be adjustable. This adjustability allows users to customize the distance between the connected individuals, catering to varying terrains, user heights, preferred proximity, and activity types. This adjustable length feature can be effectively implemented using a telescoping mechanism similar to that described for the telescoping rod embodiment, or alternatively, through the use of a series of interlocking segments that can be added or removed to modify the overall coupler length. An adjustable length coupler provides greater flexibility in adapting the device to diverse walking scenarios and user preferences.

Damping Mechanism: To further refine the smoothness and comfort of force transfer, a damping mechanism can be strategically incorporated into the coupler design. A damping mechanism is designed to reduce unwanted oscillations, vibrations, and jerky motions that might occur during walking, thereby providing a smoother and more controlled transfer of force between the individuals. This can be achieved through various damping technologies, including the integration of a hydraulic damper or shock absorber within the coupler structure, similar to those used in suspension systems, the incorporation of a friction damper that utilizes controlled friction to dissipate energy and reduce oscillations, or the use of viscoelastic materials, such as specialized polymers or gels, within the flexible portions of the coupler to absorb vibrations and provide inherent damping characteristics. A damping mechanism enhances user comfort and stability, particularly during dynamic movements and on uneven terrain.

Quick-Release Mechanism: For enhanced safety and user convenience, a quick-release mechanism can be incorporated into either the holders or the coupler itself. This feature is designed to allow for rapid and immediate disconnection of the device in case of an emergency situation, a sudden change in conditions, or simply for quick and easy removal of the device. The quick-release mechanism can be implemented using various designs, such as a readily accessible and easily operated buckle, clip, or lever system that allows for instantaneous separation of the coupler from the holders or disconnection of the holders from the users. A quick-release mechanism is a critical safety feature, particularly when using the device in potentially challenging or unpredictable environments.

Integrated Sensors: To provide valuable feedback and data about the device's usage and performance, sensors can be integrated directly into the coupler. These sensors can be strategically positioned and configured to measure various parameters, including the magnitude and direction of the force being transferred between the individuals, the relative displacement or movement between the coupler ends, or even user gait patterns. The data collected by these integrated sensors can be used to provide real-time feedback to the users, for example, through a visual display or auditory cues, allowing them to monitor the level of assistance being provided or adjust their walking style. Furthermore, the sensor data can be logged and analyzed to monitor user performance over time, track progress in rehabilitation scenarios, or optimize device design and functionality based on real-world usage data.

Storage Configuration: To enhance portability and ease of storage, the walking assistance device is specifically designed to be easily foldable, collapsible, or disassembled into a compact configuration. This storage configuration is achieved through features such as a coupler that can be folded or collapsed, holders that can be flattened or rolled up, and detachable connectors that allow for separation of components for more compact packing. The compact storage configuration makes the device convenient to transport in a backpack, travel bag, or vehicle, and facilitates efficient storage at home or during travel when the device is not in active use.

To effectively utilize the walking assistance device, the process is designed to be intuitive and user-friendly. Initially, the first individual (1101), who will be providing assistance, and the second individual (1102), who will be receiving assistance, each don the appropriately sized and adjusted holder (1103, 1104). The holders are designed for comfortable and secure wearing, whether they are harness-style, belt-style, or vest-style, ensuring a stable attachment point for the coupler. Once the holders are securely in place, the coupler (1105) is then attached to the holders using the integrated connectors (1114). The connectors, such as carabiners or clips, are designed for easy and reliable engagement with designated attachment points on the holders, ensuring a secure and robust connection. If the coupler features an adjustable length mechanism, such as a telescoping rod, the length of the coupler can be adjusted at this stage to achieve the desired distance between the first individual and the second individual, taking into account terrain, user preferences, and activity type. Prior to commencing walking, it is recommended to briefly check all connections and adjustments to ensure the device is properly and safely configured.

As the first individual initiates walking and forward motion, they can consciously and effectively provide a controlled push or pull force through the coupler (1105) to directly assist the second individual in their walking motion. The strategically engineered flexible portions (1107, 1108) of the coupler play a crucial role in accommodating the natural relative movement and independent gait patterns of the two individuals. These flexible portions allow for differences in stride length, variations in walking pace, and subtle changes in walking direction without causing jerky movements or discomfort. Simultaneously, the rigid middle portion (1106) of the coupler ensures that the applied push or pull force is efficiently and directly transferred between the individuals, maximizing the assistive effect and maintaining a stable and predictable connection. Throughout the walking activity, the device facilitates a coordinated and comfortable shared walking experience, enabling the stronger individual to provide effective assistance while preserving the natural and enjoyable aspects of walking together.

Provides effective assistance to weaker individuals during walking or travel: The primary advantage of the device is its ability to provide targeted and effective physical assistance to individuals who may have reduced strength, stamina, or mobility, such as children, elderly persons, or those recovering from injuries, making walking and hiking activities more accessible and enjoyable for them.

Allows for a more enjoyable and sustainable shared experience for both individuals: By mitigating the challenges posed by physical disparities, the device promotes a more balanced and harmonious shared experience, enabling both the assisting and assisted individuals to participate more fully and enjoyably in walking and hiking activities, fostering companionship and shared accomplishment.

Accommodates natural differences in gait, pace, and direction: The innovative flexible coupler design effectively accommodates the natural variations and asymmetries in human walking patterns, ensuring a comfortable and non-restrictive experience for both users, allowing them to walk naturally without feeling constrained or jerked by the device.

Lightweight and portable design for ease of use and transport: The device is designed to be lightweight and easily portable, utilizing lightweight materials and incorporating a foldable or collapsible storage configuration, making it convenient to carry during activities and store when not in use, enhancing its practicality and user-friendliness.

Adjustable to fit different body sizes and shapes for personalized comfort: The holders and coupler are designed with adjustability features to accommodate a wide range of body sizes and shapes, ensuring a personalized and comfortable fit for diverse users, enhancing user comfort and device effectiveness across a broad user spectrum.

Safe and comfortable to use, minimizing risk of injury: The device incorporates safety features such as quick-release mechanisms and comfortable ergonomic designs, and the flexible coupler minimizes jerky movements and stress on joints, contributing to a safer and more comfortable walking experience and reducing the risk of potential strain or injury for both users.

A walking assistance device includes:
a first holder configured to be worn by a first individual;
a second holder configured to be worn by a second individual; and
a coupler operably positioned between the first holder and the second holder and configured to flexibly transfer a push or pull force between the first individual and the second individual, the coupler comprising a substantially rigid middle portion and flexible portions located at each end of the rigid middle portion.

In some embodiments, the first holder is a harness designed to be worn around the torso of the first individual.

In some embodiments, the second holder is a harness designed to be worn around the torso of the second individual.

In some embodiments, the flexible portions comprise elastic cords constructed from a resilient material.

In some embodiments, the flexible portions comprise mechanical springs with a predetermined spring constant.

In some embodiments, the rigid middle portion is a telescoping rod adjustable in length to vary the distance between the first individual and the second individual.

In some embodiments, the first holder is adjustable in size to accommodate different body sizes of the first individual.

In some embodiments, the second holder is adjustable in size to accommodate different body sizes of the second individual.

In some embodiments, further including a quick-release mechanism integrated into at least one of the first holder, the second holder, or the coupler, configured to allow for rapid disconnection.

In some embodiments, the coupler is detachable from both the first holder and the second holder for storage and portability.

A walking assistance device is disclosed that facilitates comfortable and efficient travel between two individuals with disparate physical abilities. The device fundamentally includes a first holder ergonomically designed for a first individual, a second holder for a second individual, and a uniquely configured coupler directly connecting the first and second holders. A key innovation is that the coupler is specifically engineered to feature a substantially rigid middle section intentionally designed for efficient and direct force transfer and strategically positioned flexible end portions meticulously crafted to accommodate inherent variations in movement between the individuals. This novel design allows a stronger individual to effectively and comfortably assist a weaker individual during shared physical activities such as walking and hiking, while critically maintaining user comfort, stability, and a natural walking experience for both parties involved. The device is particularly well-suited for enhancing the participation and enjoyment of outdoor activities for dyads with differing physical capabilities, promoting inclusivity and shared physical activity.

It is apparent that those of ordinary skill in the art can make various modifications and variations to the embodiments of the disclosure without departing from the spirit and scope of the disclosure. For example, the breaking in system can also be used for body wear, especially bra or swim suit selection and breaking in. Thus, it is intended that the present disclosure cover the modifications and the modifications.

Various embodiments in this specification have been described in a progressive manner, where descriptions of some embodiments focus on the differences from other embodiments, and same or similar parts among the different embodiments are sometimes described together in only one embodiment.

Specific examples are used herein to describe the principles and implementations of some embodiments. The description is only used to help convey understanding of the possible methods and concepts. Meanwhile, those of ordinary skill in the art can change the specific manners of implementation and application thereof without departing from the spirit of the disclosure. The contents of this specification therefore should not be construed as limiting the disclosure.

In the descriptions, with respect to circuit(s), unit(s), device(s), component(s), etc., in some occurrences singular forms are used, and in some other occurrences plural forms are used in the descriptions of various embodiments. It should be noted; however, the single or plural forms are not limiting but rather are for illustrative purposes. Unless it is expressly stated that a single unit, device, or component etc. is employed, or it is expressly stated that a plurality of units, devices or components, etc. are employed, the circuit(s), unit(s), device(s), component(s), etc. can be singular, or plural.

Based on various embodiments of the present disclosure, the disclosed apparatuses, devices, and methods can be implemented in other manners. For example, the abovementioned devices can employ various methods of use or implementation as disclosed herein.

Dividing the device into different “regions,” “units,” or “layers,” etc. merely reflect various logical functions according to some embodiments, and actual implementations can have other divisions of “regions,” “units,” or “layers,” etc. realizing similar functions as described above, or without divisions. For example, multiple regions, units, or layers, etc. can be combined or can be integrated into another system. In addition, some features can be omitted, and some steps in the methods can be skipped.

Those of ordinary skill in the art will appreciate that the units, regions, or layers, etc. in the devices provided by various embodiments described above can be provided in the one or more devices described above. They can also be located in one or multiple devices that is (are) different from the example embodiments described above or illustrated in the accompanying drawings. For example, the units, regions, or layers, etc. in various embodiments described above can be integrated into one module or divided into several sub-modules.

The order of the various embodiments described above are only for the purpose of illustration, and do not represent preference of embodiments.

Although specific embodiments have been described above in detail, the description is merely for purposes of illustration. It should be appreciated, therefore, that many aspects described above are not intended as required or essential elements unless explicitly stated otherwise.

In the description of this specification, the description with reference to the terms “one embodiment,” “some embodiments,” “examples,” “specific examples,” or “some examples” and the like means specific features described in conjunction with the embodiments or examples. Structures, materials, or features are included in at least one embodiment or example of the disclosure. In this specification, the schematic expressions of the above terms are not necessarily directed to the same embodiment or example. Furthermore, the particular features, structures, materials, or characteristics described can be combined in any suitable manner in any one or more embodiments or examples. In addition, without any contradiction, those skilled in the art can combine and combine different embodiments or examples and features of the different embodiments or examples described in this specification.

Various modifications of, and equivalent acts corresponding to the disclosed aspects of the exemplary embodiments can be made in addition to those described above by a person of ordinary skill in the art having the benefit of the present disclosure without departing from the spirit and scope of the disclosure contemplated by this disclosure and as defined in the following claims. As such, the scope of this disclosure is to be accorded the broadest reasonable interpretation so as to encompass such modifications and equivalent structures.

For the convenience of description, the components of the apparatus may be divided into various modules or units according to functions which may be separately described. Certainly, when various embodiments of the present disclosure are carried out, the functions of these modules or units can be achieved utilizing one or more equivalent units of hardware or software as will be recognized by those having skill in the art.

The various device components, units, blocks, or portions may have modular configurations, or are composed of discrete components, but nonetheless can be referred to as “modules” in general. In other words, the “components,” “modules” or “units” referred to herein may or may not be in modular forms.

Persons skilled in the art should understand that the embodiments of the present disclosure can be provided for a method, system, or computer program product. Thus, various embodiments of the present disclosure can be in form of all-hardware embodiments, all-software embodiments, or a mix of hardware-software embodiments. Moreover, various embodiments of the present disclosure can be in form of a computer program product implemented on one or more computer-applicable memory media (including, but not limited to, disk memory, CD-ROM, optical disk, etc.) containing computer-applicable procedure codes therein.

Various embodiments of the present disclosure are described with reference to the flow diagrams and/or block diagrams of the method, apparatus (system), and computer program product of the embodiments of the present disclosure. It should be understood that computer program instructions realize each flow and/or block in the flow diagrams and/or block diagrams as well as a combination of the flows and/or blocks in the flow diagrams and/or block diagrams. These computer program instructions can be provided to a processor of a general-purpose computer, a special-purpose computer, an embedded memory, or other programmable data processing apparatuses to generate a machine, such that the instructions executed by the processor of the computer or other programmable data processing apparatuses generate a device for performing functions specified in one or more flows of the flow diagrams and/or one or more blocks of the block diagrams.

These computer program instructions can also be stored in a computer-readable memory, such as a non-transitory computer-readable storage medium. The instructions can guide the computer or other programmable data processing apparatuses to operate in a specified manner, such that the instructions stored in the computer-readable memory generate an article of manufacture including an instruction device. The instruction device performs functions specified in one or more flows of the flow diagrams and/or one or more blocks of the block diagrams.

These computer program instructions may also be loaded on the computer or other programmable data processing apparatuses to execute a series of operations and steps on the computer or other programmable data processing apparatuses, such that the instructions executed on the computer or other programmable data processing apparatuses provide steps for performing functions specified ill one or more flows of the flow diagrams and/or one or more blocks of the block diagrams.

Implementations of the subject matter and the operations described in this disclosure can be implemented in digital electronic circuitry, or in computer software, firmware, or hardware, including the structures disclosed herein and their structural equivalents, or in combinations of one or more of them. Implementations of the subject matter described in this disclosure can be implemented as one or more computer programs, i.e., one or more modules of computer program instructions, encoded on one or more computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, drives, or other storage devices). Accordingly, the computer storage medium may be tangible.

The operations described in this disclosure can be implemented as operations performed by a data processing apparatus on data stored on one or more computer-readable storage devices or received from other sources.

Processors suitable for the execution of a computer program such as the instructions described above include, by way of example, both general and special purpose microprocessors, and any one or more processors of any kind of digital computer. Generally, a processor will receive instructions and data from a read-only memory, or a random-access memory, or both. Elements of a computer can include a processor configured to perform actions in accordance with instructions and one or more memory devices for storing instructions and data.

The processor or processing circuit can be implemented by one or a plurality of application specific integrated circuits (ASICs), digital signal processors (DSPs), digital signal processing devices (DSPDs), programmable logic devices (PLDs), field programmable gate arrays (FPGA), controllers, microcontrollers, microprocessors, general processors, or other electronic components, so as to perform the above image capturing method.

Implementations of the subject matter and the operations described in this disclosure can be implemented in digital electronic circuitry, or in computer software, firmware, or hardware, including the structures disclosed herein and their structural equivalents, or in combinations of one or more of them. Implementations of the subject matter described in this disclosure can be implemented as one or more computer programs, i.e., one or more portions of computer program instructions, encoded on one or more computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

In some implementations, the model can reside on local processing circuits and storage devices, and the training of the model can also be performed locally. In some implementations, the model and the training can be remotely or distributed, such as in a cloud.

Data, such as the inputs, the outputs, and model predictions, can be presented to users/operators on display screens, such as organic light-emitting diode (OLED) displays screens and liquid-crystal display (LCD) screens located on a manufacturing line and/or in a control room.

Although preferred embodiments of the present disclosure have been described, persons skilled in the art can alter and modify these embodiments once they know the fundamental inventive concept. Therefore, the attached claims should be construed to include the preferred embodiments and all the alternations and modifications that fall into the extent of the present disclosure.

The description is only used to help understanding some of the possible methods and concepts. Meanwhile, those of ordinary skill in the art can change the specific implementation manners and the application scope according to the concepts of the present disclosure. The contents of this specification therefore should not be construed as limiting the disclosure.

In the foregoing method embodiments, for the sake of simplified descriptions, the various steps are expressed as a series of action combinations. However, those of ordinary skill in the art will understand that the present disclosure is not limited by the particular sequence of steps as described herein.

According to some other embodiments of the present disclosure, some steps can be performed in other orders, or simultaneously, omitted, or added to other sequences, as appropriate.

Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

In addition, those of ordinary skill in the art will also understand that the embodiments described in the specification are just some of the embodiments, and the involved actions and portions are not all exclusively required, but will be recognized by those having skill in the art whether the functions of the various embodiments are required for a specific application thereof.

Various embodiments in this specification have been described in a progressive manner, where descriptions of some embodiments focus on the differences from other embodiments, and same or similar parts among the different embodiments are sometimes described together in only one embodiment.

It should also be noted that in the present disclosure, relational terms such as first and second, etc., are only used to distinguish one entity or operation from another entity or operation, and do not necessarily require or imply these entities having such an order or sequence. It does not necessarily require or imply that any such actual relationship or order exists between these entities or operations.

Moreover, the terms “include,” “including,” or any other variations thereof are intended to cover a non-exclusive inclusion such that a process, method, article, or apparatus that comprises a list of elements including not only those elements but also those that are not explicitly listed, or other elements that are inherent to such processes, methods, goods, or equipment.

In the case of no more limitation, the element defined by the sentence “includes a . . . ” does not exclude the existence of another identical element in the process, the method, the commodity, or the device including the element.

In the descriptions, with respect to device(s), terminal(s), etc., in some occurrences singular forms are used, and in some other occurrences plural forms are used in the descriptions of various embodiments. It should be noted, however, that the single or plural forms are not limiting but rather are for illustrative purposes. Unless it is expressly stated that a single device, or terminal, etc. is employed, or it is expressly stated that a plurality of devices, or terminals, etc. are employed, the device(s), terminal(s), etc. can be singular, or plural.

Based on various embodiments of the present disclosure, the disclosed apparatuses, devices, and methods can be implemented in other manners. For example, the abovementioned terminals devices are only of illustrative purposes, and other types of terminals and devices can employ the methods disclosed herein.

Dividing the terminal or device into different “portions,” “regions” “or “components” merely reflect various logical functions according to some embodiments, and actual implementations can have other divisions of “portions,” “regions,” or “components” realizing similar functions as described above, or without divisions. For example, multiple portions, regions, or components can be combined or can be integrated into another system. In addition, some features can be omitted, and some steps in the methods can be skipped.

Those of ordinary skill in the art will appreciate that the portions, or components, etc. in the devices provided by various embodiments described above can be configured in the one or more devices described above. They can also be located in one or multiple devices that is (are) different from the example embodiments described above or illustrated in the accompanying drawings. For example, the circuits, portions, or components, etc. in various embodiments described above can be integrated into one module or divided into several sub-modules.

The numbering of the various embodiments described above are only for the purpose of illustration, and do not represent preference of embodiments.

Although specific embodiments have been described above in detail, the description is merely for purposes of illustration. It should be appreciated, therefore, that many aspects described above are not intended as required or essential elements unless explicitly stated otherwise.

Various modifications of, and equivalent acts corresponding to, the disclosed aspects of the exemplary embodiments, in addition to those described above, can be made by a person of ordinary skill in the art, having the benefit of the present disclosure, without departing from the spirit and scope of the disclosure defined in the following claims, the scope of which is to be accorded the broadest interpretation to encompass such modifications and equivalent structures.

What is claimed is:

1. An apparatus configured to break in footwear or sportswear, comprising:
a three-dimensional model of a user's feet or body based on scanning or molding; wherein the three-dimensional model comprises a material configured to mimic biomechanical properties of the user's feet or body;
a robotic motion simulator configured to simulate user-specific movements to break in the footwear or sportswear; and
a controller configured to customize break-in protocols based on user-specific parameters, to thereby break in the footwear or sportswear emulating a process of the user's wearing the footwear or sportswear to break in without user discomfort while optimizing fit of the footwear or sportswear.

2. The apparatus of claim 1, wherein the scanning or molding comprises 3D scanning or photogrammetry.

3. The apparatus of claim 1, wherein the three-dimensional model captures anatomical features including arch height, toe structure, and skin texture.

4. The apparatus of claim 1, wherein the material substantially replicates flexibility and thermal characteristics of the user's feet or body.

5. The apparatus of claim 1, wherein the robotic motion simulator is configured to substantially replicate human motions including walking, running, and sport-specific actions.

6. The apparatus of claim 1, wherein the controller is configured to adjust simulation parameters based on user-specific data including weight distribution, gait analysis, and activity type.

7. A method for breaking in footwear or sportswear, comprising:
generating a 3D model of a user's feet or body based on scanning or molding; wherein the three-dimensional model comprises a material configured to mimic biomechanical properties of the user's feet or body;
fitting the footwear or sportswear onto the 3D model;
simulating user-specific movements with a robotic motion simulator to break in the footwear or sportswear; and
customizing the break-in protocol based on user-specific parameters to reduce user discomfort and optimize fit.

8. The method of claim 7, wherein the 3D model captures anatomical features including arch height, toe structure, and skin texture.

9. The method of claim 7, wherein the material selection includes emulating flexibility and thermal characteristics of the user's feet.

10. The method of claim 7, wherein the robotic motion simulator substantially replicates user-specific movements including walking, running, and sport-specific actions.

11. The method of claim 7, wherein the break-in protocol is customized based on user-specific data including weight distribution, gait analysis, and activity type.

12. A system for pre-conditioning footwear and sportswear, comprising:
a 3D model creator module configured to generate a detailed model of a user's feet or body;
a material emulator configured to selecting materials that mimic the user's biomechanical properties;
a robotic motion simulator configured to simulate user-specific movements; and
a controller configured to customize break-in protocols,
wherein the system is configured to enhance fit and comfort of the footwear or sportswear for the user.

13. The system of claim 12, wherein the 3D model includes anatomical features including arch height, toe structure, and skin texture.

14. The system of claim 12, wherein the material emulator selects materials that substantially replicate flexibility and thermal characteristics of the user's feet or body.

15. The system of claim 12, wherein the robotic motion simulator is configured for user-specific movements including walking, running, and sport-specific actions.

16. The system of claim 12, wherein the controller is configured to adjust simulation parameters based on user-specific data including such as weight distribution, gait analysis, and activity type.

17. The system of claim 12, further comprising a coupling device configured to couple two moving bodies.

18. The system of claim 17, wherein the coupling device comprises a first wearable for fitting into the first moving body, a second wearable for fitting into the second moving body; a substantially rigid portion configured conduct push and pull forces between the first moving body and the second moving body; a first coupler and a second coupler respectively coupling the first moving body and the second moving body respectively with the substantially rigid portion and configured to be partially flexible.

19. The system of claim 18, wherein the first coupler and the second coupler are configured to allow relative movement between the first moving body and second moving body while provide increasing resistance when the relative movement increases, to thereby prevent one of the first moving body and the second moving body falling.

20. The system of claim 19, wherein the resistance includes a rotational resistance to prevent one of the first moving body and the second moving body falling sideways.
